(19) United States
(12) Patent Application Publication
(10) Pub. No.: US 2008/0162184 A1
(43) Pub. Date: Jul. 3, 2008

(54) MEDICAL SERVICE SUPPORT SYSTEM

(75) Inventors: Nobuaki MATSUBARA, Saitama (JP); Hidenobu KUBO, Tokyo (JP); Shigeyoshi BABA, Kanagawa (JP); Hiroshi FUJIMOTO, Tokyo (JP); Atsushi KUSUOKA, Tokyo (JP); Atsushi SUGIYAMA, Tokyo (JP); Hirofumi INABA, Kanagawa (JP); Yusuke KATO, Tokyo (JP); Hiroyuki ARAKI, Kanagawa (JP); Hideki YASUDA, Tokyo (JP); Hitoshi SUZUKI, Tokyo (JP)

Correspondence Address: SCULLY SCOTT MURPHY & PRESSER, PC, 400 GARDEN CITY PLAZA, SUITE 300, GARDEN CITY, NY, 11530, US

(73) Assignee: OLYMPUS MEDICAL SYSTEMS CORP., Tokyo (JP)

(21) Appl. No.: 11/870,848

(22) Filed: Oct. 11, 2007

(30) Foreign Application Priority Data
Oct. 11, 2006 (JP) 2006-277194
Oct. 11, 2006 (JP) 2006-277195
Oct. 11, 2007 (JP) 2007-265144

(51) Int. Cl. G06Q 50/00

(52) U.S. Cl. 705/2

(57) ABSTRACT

A medical service support system is provided which manages a use state of medical instrument used in medical operations with predetermined task sequence is provided. A reading unit reads use state specifying information recorded in the use state specifying information recording unit before the medical instruments are used for a certain task. A determination unit determines whether the use of the medical instrument for the task follows the task sequence from use state specifying information read. A writing unit writes, in the use state specifying information recording unit, the use state specifying information which specifies that the task is executed when the task is executed by a task execution unit.

### CROSS-REFERENCE TO RELATED APPLICATIONS

This application is based upon and claims the benefit of priority from the prior Japanese Patent Application No. 2006-277194, filed on Oct. 11, 2006, Japanese Patent Application No. 2006-277195, filed on Oct. 11, 2006, and Japanese Patent Application No. 2007-265144, filed on Oct. 11, 2007, the entire contents of which are incorporated herein by reference.

### BACKGROUND OF THE INVENTION

1. Field of the Invention

The present invention relates to medical service support systems. In particular, the invention relates to medical service support systems for managing use state of medical instruments used for medical operations and/or status of medical resources.

2. Description of the Related Art

For an endoscopic examination, an endoscope system is used in which a long and thin scope with image capturing unit is inserted in a patient's body and the images of the examined areas are photographed by the image capturing unit and displayed on a monitor. The endoscope system is placed in an examination room and a nurse brings a scope that matches the patient's examination and connects the scope to the endoscopic device in order to conduct an examination. In the related art, endoscopic image filing system which creates examination schedule automatically has been suggested to conduct endoscopic examination efficiently (e.g. patent document 1). Patent document 1 is directed to an efficient use of examination rooms by creating a new examination schedule for the non-reserved hours based on the schedule already registered.

Also, with regard to medical service support system, it has been suggested that medical practice be managed using the medical orders issued by doctors and nurses (e.g. patent document 2). With this kind of service support system, doctors conduct medical practices by following the medical orders containing examination and treatment information. In the service support system disclosed in patent document 2, for example, medical instruments to be used for the operative methods required in medical orders can be selected from the database. In this manner, information management with medical practices, such as examinations and treatments, as a key is achieved in the service support system disclosed in patent document 2.

[Patent document 1] Japanese Laid-Open Publication No.

[Patent document 2] Japanese Laid-Open Publication No. 2006-178919

In endoscopic examination operations, used scopes need to be washed right away with a washing device. The washed scopes are stored in storage and a nurse brings them from the storage and connects them to the endoscopic device for next examination. Thus, in endoscopic examination operations, scopes are used in a sequence of a series of tasks which includes using, washing, and storing.

However, it is not simple to confirm that a scope is treated in a correct predetermined sequence in the operations. For example, even though scopes stored in storage are supposed to be already washed, it is not easy to confirm that the scopes taken out from storage are already washed when they are to be used for examinations. Even if the scopes are already washed, the washing process may have been taken place a couple of weeks before and the use of these scopes is not desirable. Due to this kind of situation, a technique is desired in which endoscopic examination operations are carried out smoothly by managing a status of scope use appropriately. Also, the same situation applies to other medical operations and a smooth and safe execution of medical operations is a major challenge for those who are engaged in medical care.

When a scope is used for a patient with infectious disease, a nurse is required to pay careful attention to the handling of the scope during washing. It is preferable to establish an arrangement which indicates that a scope is used for a patient with infectious disease and an arrangement which indicates other useful information if scope washing is processed by a nurse who does not witness the examination.

In examination operations, a nurse is conventionally required to check visually that the examination room is unoccupied and a scope to be used for the examination is washed before the examination. As stated previously, since washed scopes are stored in a storage such as warehouse, going back and forth between an examination room and a storage for confirmation process is time consuming if the examination room and the storage are located far away from each other.

At a large-scale hospital, several endoscopic examination rooms are established for, for example, respective examination categories and multiple examinations are conducted by a number of doctors in one day. In recent years, with a growing request for patients' privacy protection, the examination rooms are often blocked from each other with a cement wall making nurse's situation awareness of scope use in each examination room difficult. Also, examinations can be started at the same time in different examination rooms in a hospital with several examination rooms, however, if there is only one scope available, patients as well as doctors are required to wait resulting in non-efficient examination performance.

### SUMMARY OF THE INVENTION

In this background, a general purpose of the present invention is to provide a system which executes efficient medical operations by managing a use state of a medical instrument. An additional purpose of the present invention is to provide a medical instrument management device and a medical service support system which enable medical practitioners including doctors to easily keep track of, for example, a use state of medical instrument. An additional purpose of the present invention is to provide a medical instrument management device and a medical service support system which accomplish the environment in which an order can be executed efficiently, by referring to the use state of medical instrument.

A medical service support system according to one embodiment of the present invention manages a use state of medical instrument used in medical operations with a predetermined task sequence, and comprises:

a recording unit operative to record use state specifying information which specifies a use state of medical instrument;

a reading unit operative to read use state specifying information recorded in the recording unit before the medical instrument is used for a certain task;

a first determination unit operative to determine whether the use of the medical instrument for the task follows the task sequence from use state specifying information read; and

a task execution unit operative to execute the task when the first determination unit determines that the task sequence is properly followed.

According to this embodiment, in executing a task, by determining whether the task follows a predetermined task sequence, by referring to the use state of the medical instrument, a risk to execute an undesired task is prevented, and thus a safety of the medical operation is further ensured. The task execution unit may be a unit to accomplish the original function of the task execution device, for example, a unit which executes an observation function of an observation device, a unit which executes a washing function of a washing device, and a unit which executes a management function of a storing management device.

A medical service support system according to another embodiment of the present invention comprises:

an order information memory unit operative to store order information of a medical practice to be performed;

an order information acquisition unit operative to acquire order information indicating an order for the medical practice which is scheduled to be started, from the order information memory unit;

an status information acquisition unit operative to acquire status information of a medical resource;

a determination unit operative to determine from the order information acquired by the order information acquisition unit whether there is the medical practice which requires the use of the medical resource when the status information of the medical resource acquired by the status information acquisition unit indicates the medical resource to be in a usable state; and

an annunciation unit operative to announce that the order of a medical practice can be executed when the determination unit determines that there is a medical practice which requires the use of the medical resource.

According to this embodiment, a required medical resource can be prepared smoothly during a preparation for a medical practice, since the medical practice is extracted which requires the medical resource from medical resources in a usable state.

Optional combinations of the aforementioned constituting elements, and implementations of the invention in the form of methods, apparatuses, systems, recording mediums and computer programs may also be practiced as additional modes of the present invention.

### BRIEF DESCRIPTION OF THE DRAWINGS

FIG. 1 is a view illustrating a configuration of medical service support system according to the embodiment 1 of the present invention.

FIG. 2 is a view illustrating a use transition of an endoscope.

FIG. 3 is a view illustrating an internal configuration of an information management device.

FIG. 4 is a view illustrating a task execution table which defines the task sequence retained in task flow memory unit.

FIG. 5 is a view illustrating an internal configuration of an endoscopic observation device.

FIG. 6 is a flowchart showing a process of determining the properness of task execution by the information management device prior to the installation of an endoscope on an endoscopic observation device by medical practitioners.

FIG. 7 is a view illustrating an internal configuration of a washing device.

FIG. 8 is a flowchart showing a process of determining the properness of task execution by the information management device prior to the installation of an endoscope on a washing device by medical practitioners.

FIG. 9 is a view illustrating an internal configuration of a storage management device.

FIG. 10 is a flowchart showing a process of determining the properness of task execution by the information management device prior to the storing of an endoscope in scope storage by medical practitioners.

FIG. 11 is a view illustrating an example of the use state specifying information recorded at the use state specifying information recording unit.

FIG. 12 is a view illustrating an internal configuration of PDA according to the embodiment 2.

FIG. 13 is a view illustrating an internal configuration of an endoscope.

FIG. 14 is a view illustrating an internal configuration of an endoscopic observation device, a washing device, and a storage management device according to the embodiment 3.

FIG. 15 is a view illustrating an example of the information recorded in the endoscope memory.

FIG. 16 is a view illustrating a configuration of a medical service support system according to the embodiment 4 of the present invention.

FIG. 17 is a view illustrating an internal configuration of an in-examination-room terminal device and an endoscopic device provided in an examination room.

FIG. 18 is a view illustrating an internal configuration of a washing device.

FIG. 19 is a view illustrating an internal configuration of a storage management device.

FIG. 20 is a view illustrating an internal configuration of the examination management device.

FIG. 21 is a view illustrating a status transition of an endoscope.

FIG. 22 is a view illustrating a table mapping the scope identification number to an examination category for which the scope is used.

FIG. 23 is a view illustrating an example of the examination management screen displayed on a display unit.

FIG. 24 is a view illustrating an example of the examination management screen displayed on a display unit.

FIG. 25 is a view illustrating an example of examination management screen displayed on a display unit.

FIG. 26 is a view illustrating massage examples displayed on PDA.

FIG. 27 is a view illustrating a flowchart of the examination management process.

FIG. 28 is a view illustrating a variation example of the examination management process flowchart.

### DETAILED DESCRIPTION OF THE INVENTION

The invention will now be described by reference to the preferred embodiments. This does not intend to limit the scope of the present invention, but to exemplify the invention.

The medical service support system according to the embodiments 1-4 of the present invention will be explained as follows. The medical service support systems described in these embodiments may be constructed independently from the systems described in the other embodiments or it can be constructed in relation with each other. By combining the inventions shown in each embodiment, a use state of medical instruments and a status of medical resources can be managed efficiently. The use state of medical instruments, which is a concept focused on the task sequence which constitutes the medical operations, is information that specifies the operation stage in the predetermined task flow. The status of medical resources including medical instruments, which is a concept focused on a current state of medical resources, is information that specifies the current state of medical resources.

The medical service support system in the embodiments 1-3 features a function of managing the use of medical instruments used for medical operations in the predetermined task sequence in accordance with the medical operation flow. With this, a medical service support system is capable of determining whether the transition to the next task is warranted, thereby enabling risk management in the medical operations. Also, the medical service support system features a function to present and indicate the information including the use state of medical instruments to medical practitioners such as nurses. In this manner, the medical practitioners can easily obtain the information on medical instruments, resulting in smooth and safe process of medical operations.

The embodiments 1-3 illustrate the medical service support system which supports the endoscopic examination operations by managing the use state of an endoscope. The endoscope is assigned unique identification information and the medical service support system enables the individual management of the endoscope based on the individually assigned identification information. The identification information may be recorded at the memory in the endoscope and stored as a data code, and it may also be attached on the surface of the endoscope as two-dimensional code information. The medical service support system can be used not only for the endoscopic examination operations but also for other medical practices.

The medical service support system in the embodiment 4 is provided with an examination management device that enables the efficient process of examinations by managing the use state, also called as status, of medical resources. The examination management device can also be called a medical resources management device or medical instrument management device since it manages the use state of medical resources. In the embodiment 4, the term “medical resources” refers to the medical practitioners including doctors, nurses, and laboratory technicians who are engaged in medical practices; the facilities including examination rooms and operation rooms where medical practices are performed; and medical instruments used for the examinations including equipments and medical materials. The examination rooms, as referred to in this specification, include spaces, or rooms, where the medical practices such as treatments and operations as well as examinations are performed, and the rooms called treatment rooms and operation rooms.

In the embodiment 4, the examination management system, which manages the endoscopic examination, is illustrated and the examination management device manages the use state of the endoscope. The endoscope has unique identification information and the examination management device enables the individual management of the endoscope based on the individual identification information. As described above, use state management of the medical resources by the medical service support system in the embodiment 4 allows the management of the use state of the medical resources, and the performance and the schedule of medical practices. In the following paragraphs, each embodiment is described in details.

### EMBODIMENT 1

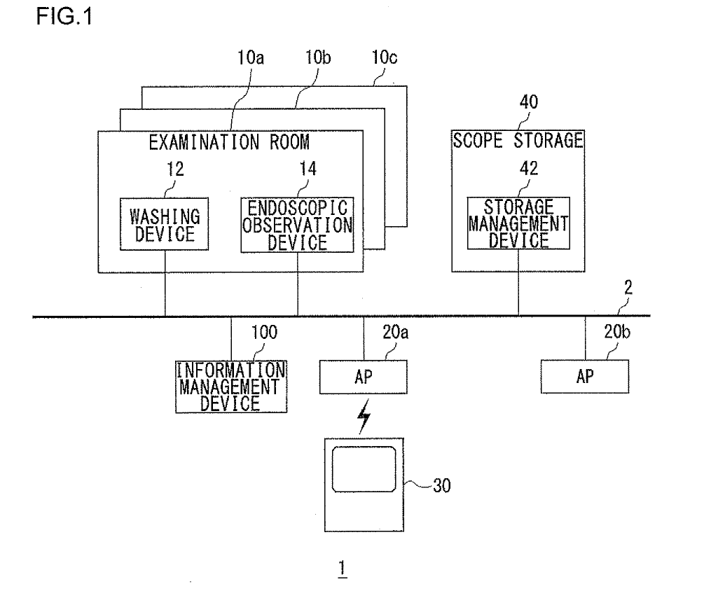

FIG. 1 shows a configuration of a medical service support system 1 according to the embodiment 1 of the present invention. The medical service support system 1 according to the embodiment 1 has an information management device 100 which facilitates the smooth execution of the medical operations including endoscopic examination operations. In the medical service support system 1, the information management device 100, the washing device 12, the endoscopic observation device 14, the access points (AP) 20a and 20b, and the storage management device 42 are connected to the local area network (LAN) 2 so that they can communicate with each other. The medical service support system 1 manages the use state information that relates to the use state of the medical instrument including the endoscope.

The medical service support system 1 encompasses several examination rooms 10a, 10b, and 10c (hereinafter, generically referred to as “examination room 10”) to perform the endoscopic examinations. Installed in the examination room 10 are the endoscopic device to which endoscope is connected and the endoscopic observation device 14 which includes an examination terminal device to display the images captured by the endoscope on a monitor and perform the saving process of the displayed. The washing device 12 which washes a used endoscope is also installed in the examination room 10. The already washed endoscope is taken to and stored at the scope storage 40, which is located outside of the examination room, and the storage management device 42 manages the storage of the endoscope.

The information management device 100 has the function of managing the use state of the endoscope in accordance with the endoscopic examination operation flow. In this specification, there are five use states for the endoscope referred to as “in use for examinations”, “used for examinations”, “in washing process”, “already washed”, and “stored”.

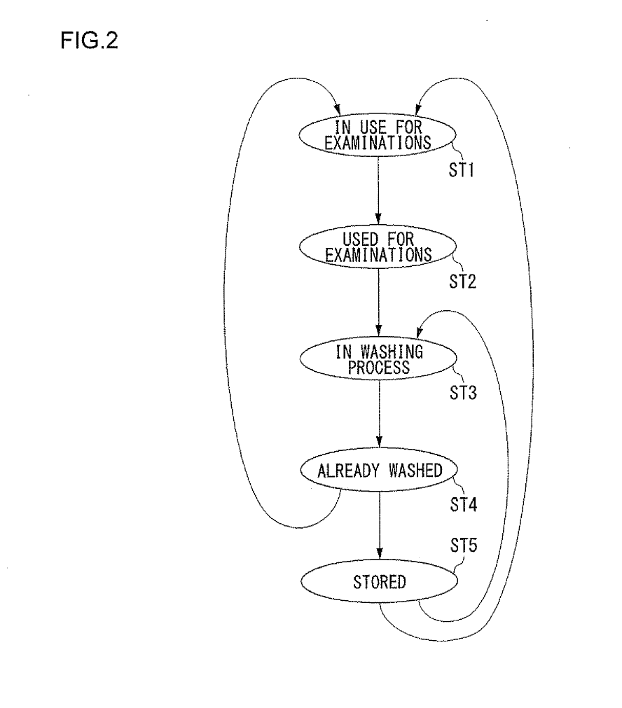

FIG. 2 is the diagram showing the transition in the use of the endoscope. In the medical service support system 1 in the embodiment 1, the information management device 100 manages the endoscope according to the five use states referred to as “in use for examinations” (ST1), “used for examinations” (ST2), “in washing process” (ST3), “already washed” (ST4), and “stored” (ST5). In FIG. 2, the use state being managed may transit only in the direction indicated by arrows. In another example, the endoscope may be managed according to individually segmentalized use states, and new use states such as “out on loan” and “out of order” can be added.

A state “in use for examinations” indicates a state in which the endoscope is in use being connected to the endoscopic observation device 14. A state “used for examinations” indicates a state in which the endoscope is removed from the endoscopic observation device 14 after the endoscopic examination. A state “in washing process” indicates a state in which the endoscope is installed on the washing device 12 and being washed. A state “already washed” indicates a state in which the endoscope is removed from the washing device 12 after the washing process is completed. A state “stored” indicates a state in which the already washed endoscope is stored in the scope storage 40.

The diagram showing the transition of use state shown in FIG. 2 defines a sequence of the series of tasks constituting the endoscopic examination operations using the endoscope, and the information management device 100 retains a sequence of a series of tasks as a task flow. The information management device 100 manages the latest state of endoscope use, and before the medical practitioners use the endoscope for a certain operation, the device determines if the operation follows the operation flow retained in the device. If the operation follows the task flow, the operation can be performed. However, if the operation does not follow the operation flow, the operation cannot be performed. For example, even if the endoscope in “used for examinations” state is about to be stored in the scope storage 40, the storage of the scope in the scope storage 40 cannot be permitted by the information management device 100 since this transition of the use state is not defined in the diagram showing the transition of the use state. In this case, the information management device 100 can avoid the storage of the endoscope not yet washed by notifying the medical practitioners of a need to perform the washing process.

The medical service support system 1 also has more than one access points including AP 20a and AP 20b (hereinafter, generically referred to as “AP 20”). A plurality of the AP 20s is installed in the hospital and in the examination room 10 so that the signal from PDA (Personal Digital Assistant) 30 is received. The PDA 30 is a portable terminal device carried by the medical practitioners such as nurses and can send and receive data to/from the AP 20.

In addition to the regular PDA features such as data input means using touch-panels, data input processing means such as a CPU, data memory means, and display means for processed data, the PDA 30 has built-in features such as a wireless LAN card which enables the wireless communication with the AP 20 through the wireless LAN and reading means for reading the identification information assigned to patients and medical instruments. The reading means of the PDA 30 may be an optical reader which reads two- or three-dimensional identification codes optically, or a RF reader which reads the identification information through electric waves and electromagnetic waves from a RFID (Radio Frequency IDentification) tag. When the identification information assigned to medical instruments is read by the PDA 30, an entry screen is displayed on a display unit to prompt the input of, for example, the details of the scheduled tasks which requires the use of the medical instruments, and a nurse inputs the details of the operations for the medical instruments. With regard to the embodiment 2, when a nurse reads the identification information assigned to an endoscope using the PDA 30, a screen to inquire the task details is displayed on the display unit of the PDA 30 and the nurse inputs the task details of the endoscope using the input means.

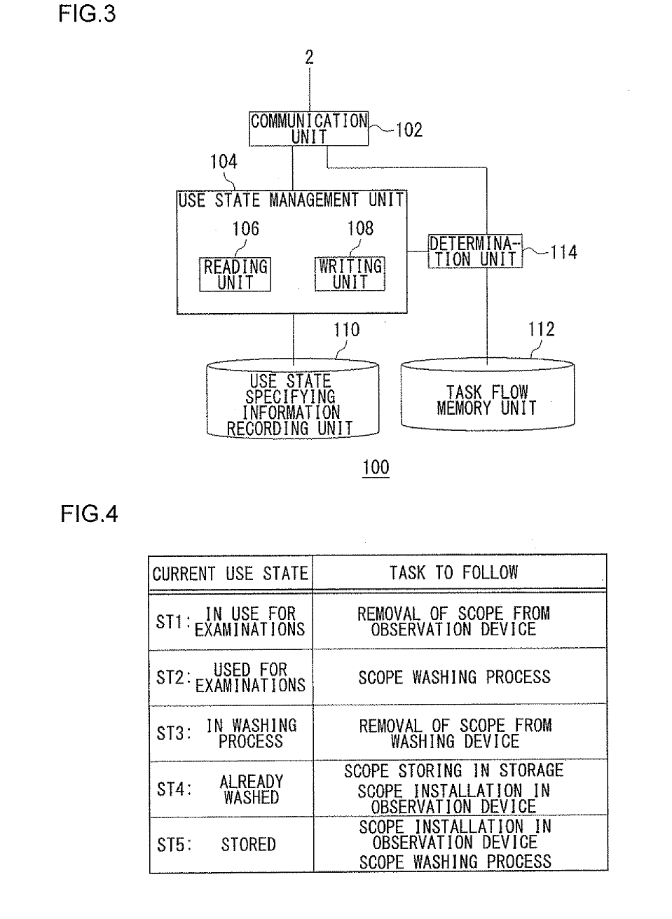

FIG. 3 shows the internal configuration of an information management device 100. The information management device 100 is composed of a communication unit 102, a use state management unit 104, a use state specifying information recording unit 110, an task flow memory unit 112, and a determination unit 114. The use state specifying information unit 110 records the use state specifying information which specifies the use state of the endoscope. The use state specifying information may be any information as long as it can specify the current use state. As a simple example, it may be the information which directly specifies the current use state. As shown in FIG. 2, the endoscope removed from the endoscopic observation device 14 after the endoscopic examination is at the use state of “used for examinations” and the endoscope removed from the washing device 12 after the washing process is at the use state of “already washed”. Thus, by considering the use state to be the use state specifying information, the current use state and the latest use state specifying information can be easily connected to each other.

As another example, the use state specifying information may be information which specifies the next use or task to follow the current state. For example, since the endoscope at the “used for examinations” state is required to follow the washing process, the use state specifying information may be information which assigns “washing process”, as an information which specifies the task to follow. Even in this kind of situation, the information which specifies the use state to follow is still the information which specifies the current use state. The use state specifying information may also be of a data format which expresses whether a cycle of tasks, from the examination to washing to storing, is conducted or not as a flag. For respective use state which has changed due to the task performed, the new use state specifying information may be recorded in the data format.

The task flow memory unit 112 retains a sequence of a series of tasks which constitutes the endoscopic examination tasks. As described previously, in the endoscopic examination operation flow, the tasks are required to be processed in a predetermined manner. For example, the task flow memory unit 112 may retain a sequence of a series of tasks as a whole, with a table which specifies the details of the task to follow the current use state.

FIG. 4 shows a task execution table which defines the task sequence retained in the task flow memory unit 112. In this task execution table, the task to follow is recorded in relation with the current use state. This correspondence relation, which is shown in the diagram of FIG. 2 showing the use state transition, represents as the relation between the current use state and the details of the task to follow. The task ID in relation with the task details may be recorded in the item “task to follow” in the task execution table.

The communication unit 102 obtains the identification information of the endoscope, the use state specifying information, and the details of the task to follow, from the washing device 12, the endoscopic observation device 14, and the storage management device 42, through the connection with LAN2. The details of the task to follow may be determined by the determination unit 114 from the source of the identification information. Also, the use state specifying information and the details of the task to follow may be provided by the PDA 30 through the AP 20.

The use management information unit 104 has a reading unit 106 and a writing unit 108, and when the communication unit 102 receives the identification information of the endoscope and the latest use state specifying information, the writing unit 108 writes the use state specifying information in the use state specifying information recording unit 110 in relation with the identification information. Also, when the communication unit 102 receives the identification information of the endoscope and the details of the task which is about to be performed by the medical practitioner, the reading unit 106 reads, before the endoscope is used for the task, the use state specifying information from the use state specifying information recording unit 110 with the identification information of the endoscope as a key and provides the use state specifying information to the determination unit 114. As described previously, the determination unit 114 may obtain the details of the task which is about to be performed by medical practitioners from the source of the identification information of the endoscope.

The determination unit 114 determines whether the use of the endoscope for the next task follows the task sequence, in accordance with the use state specifying information read from the use state specifying information recording unit 110. With this, the endoscopic examination operation in the predetermined sequence can be achieved and the safety of the examination operation is further ensured.

Based on the task sequence retained in the task flow memory unit 112, the determination unit 114 may extract the task to be performed from the read use state specifying information and determine if the task in which the endoscope is about to be used matches the task extracted. For example, if the current use state read from the use state specifying information recording unit 110 is “used for examinations” state, the determination unit 114 determines that the next task is “scope washing process” in accordance with the task execution table in task flow memory unit 112. If the details of the next task received by the communication unit 102 indicate “scope washing process”, the determination unit 114 determines that the task follows the predetermined sequence. The determination unit 114 may send a message through the communication unit 102 indicating a task execution permission to any task execution devices, for example, the washing device 12, the endoscopic observation device 14, and the storage management device 42, in which the next task is performed. When the message is confirmed, the medical practitioner uses the endoscope in the task execution device and the task execution device performs its task using task execution means.

The determination unit 114 may extract the current use state specifying information from the task in which the endoscope is about to be used, based on the task sequence retained in the task flow memory unit 112, and determine if it matches the use state specifying information read. For example, if the task in which the endoscope is about to be used is in a “scope washing process” state, the determination unit 114 discovers from the task execution table shown in FIG. 4 that the current use state is “used for examinations” or “stored”. If the use state specifying information, read from the use state specifying information recording unit 110, indicates “used for examinations” as a use state, the determination unit 114 determines that the task about to be performed follows the predetermined sequence.

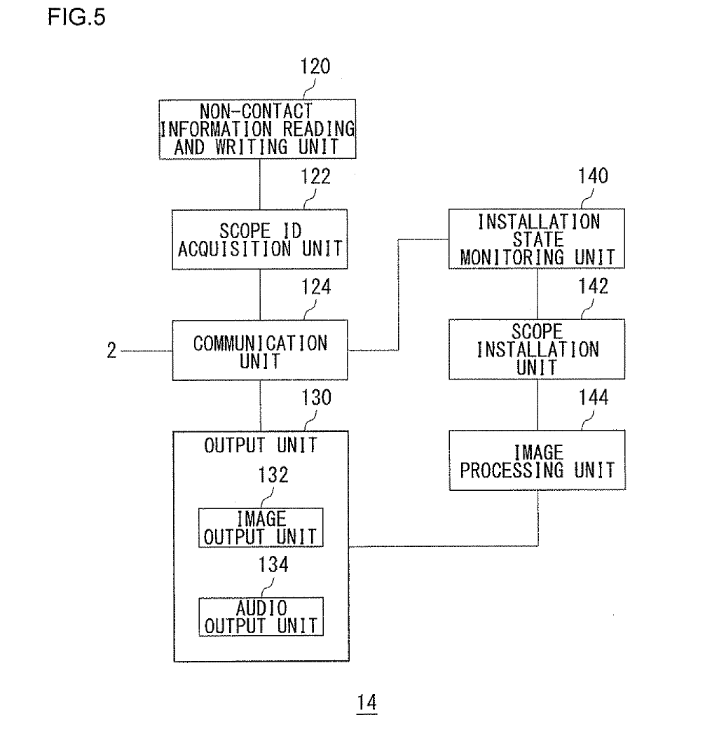

FIG. 5 shows an internal configuration of the endoscopic observation device 14. The endoscopic observation device 14 is provided with a non-contact information reading and writing unit 120, a scope ID acquisition unit 122, a communication unit 124, an output unit 130, an installation state monitoring unit 140, a scope installation unit 142, and an image processing unit 144.

A non-contact information reading and writing unit 120 is a non-contact information reading means which reads the identification information recorded in the endoscope memory. For example, REID tag is attached to the endoscope, and the non-contact information reading and writing unit 120 can read the identification information from the endoscope by an electromagnetic induction method or an electric wave method. The non-contact information reading and writing unit 120 may be an optical reader which reads two dimensional codes attached to the surface of the endoscope. For example, when a nurse brings an endoscope close to the non-contact information reading and writing unit 120, the non-contact information reading and writing unit 120 can read the identification information. The scope ID acquisition unit 122 acquires the identification information (scope ID) read from non-contact information reading and writing unit 120, and the communication unit 124 sends the scope ID to the information management device 100.

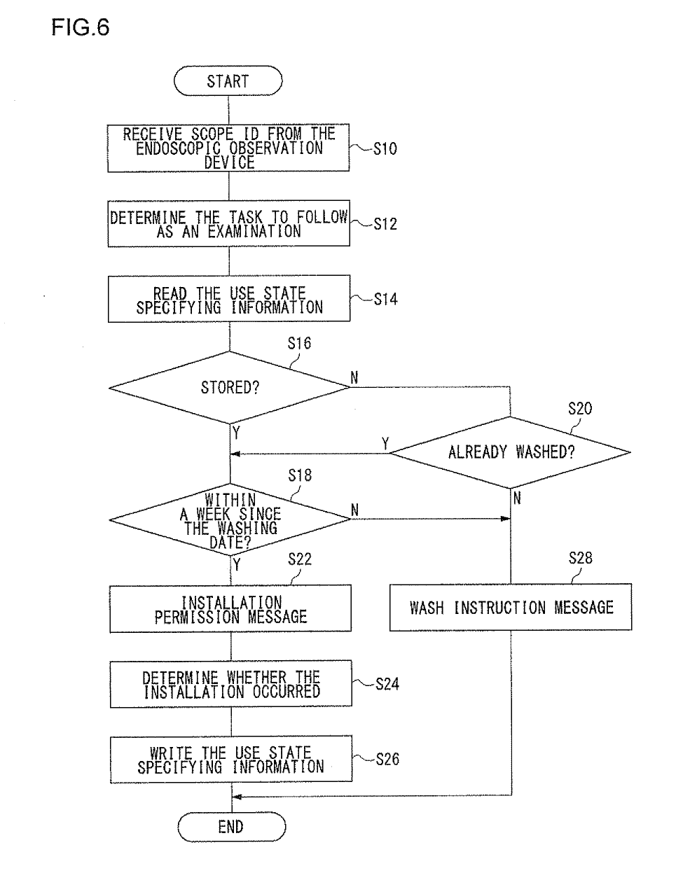

FIG. 6 is a flowchart showing a process of determining the properness of task execution by the information management device 100 prior to the installation of an endoscope on an endoscopic observation device 14 by medical practitioners. Referring to FIG. 3, the communication unit 102 receives scope ID from the endoscopic observation device (S10). The determination unit 114 determines that the endoscope is to be used for endoscopic examination as the scope ID is received from the endoscopic observation device 14 (S12). The determination unit 114 learns that the current use state needs to be “stored” or “already washed” for the installation of a scope on the endoscopic observation device 14 in accordance with the task execution table retained in the task flow memory unit 112. The reading unit 106 reads the use state specifying information recorded in relation with the scope ID from the use state specifying information recording unit 110 (S14).

When the use state specifying information read is “stored” (Y in S16), the determination unit 114 determines whether one week has passed since the washing date (S18). Also, when the use state specifying information read is not “stored” (N in S16) but “already washed” (Y in S20), the determination unit 114 determines whether one week has passed since the washing date (S18). If the washing was done within a week (Y in S18), the determination unit 114 generates an installation permission message (S22) and sends the message to the communication unit 124 in the endoscopic observation device 14 through the communication unit 102. On the other hand, if the use state of the endoscope is not “already washed” (N in S20), and a week or more has passed since the washing date (N in S18), the determination unit 114 generates a wash instruction message (S28) and sends the message to the communication unit 124 in the endoscopic observation device 14 through the communication unit 102.

Referring to FIG. 5, the communication unit 124 provides a message sent from the communication unit 102 to the output unit 130 and the output unit 130 outputs the message. In the output unit 130, an image output unit 132 may display the message on a display unit and an audio output unit 134 may output the message through a speaker. When the installation permission massage is confirmed, a medical practitioner installs the endoscope on the scope installation unit 142; and when the wash instruction message is confirmed, the medical practitioner calls off the installation of the endoscope on the scope installation unit 142, being aware of the need for the endoscope washing. In this manner, by managing the use state in accordance with the endoscopic examination operation flow, the situation can be avoided in which unwashed endoscopes or the endoscopes, which had been washed quite a while before, are used for examinations, resulting in a safe endoscopic examination.

If an endoscope is installed on the scope installation unit 142, the installation state monitoring unit 140 learns that the installation has occurred (S24) and the communication unit 124 sends the information that specifies the installation to the communication unit 102. The writing unit 108 writes the use state specifying information in use state specifying information recording unit 110 (S26). In this manner, the use state specifying information recording unit 110 becomes capable of retaining the latest use state specifying information “in use for examinations”. If only the latest use state specifying information needs to be retained, the use state specifying information may be overwritten.

After the examination preparation is completed, a doctor inserts an endoscope into a patient's body and image processing unit 144 outputs the examined-area image data, captured by the image capturing unit at the tip of the scope, from the image output unit 132 after the images are converted to the predetermined display format. With this, the image output unit 132 outputs and displays the captured internal-body images in real time. The doctor manipulates the endoscope while watching the internal-body images displayed, and when a release switch (not shown) of the endoscope is pushed, the image-processing unit 144 compresses and saves the image data in a recording device (not shown). In this manner, a desired image of, for example, an examined area can be saved in the recording device as a still image.

When the installation state monitoring unit 140 detects that the endoscope is removed from the scope installation unit 142 after the examination is completed, the communication unit 124 sends the information which specifies the removal of the scope to the communication unit 102. The writing unit 108 writes the use state specifying information in the use state specifying information recording unit 110. With this, the use state of the endoscope is changed to “used for examinations”.

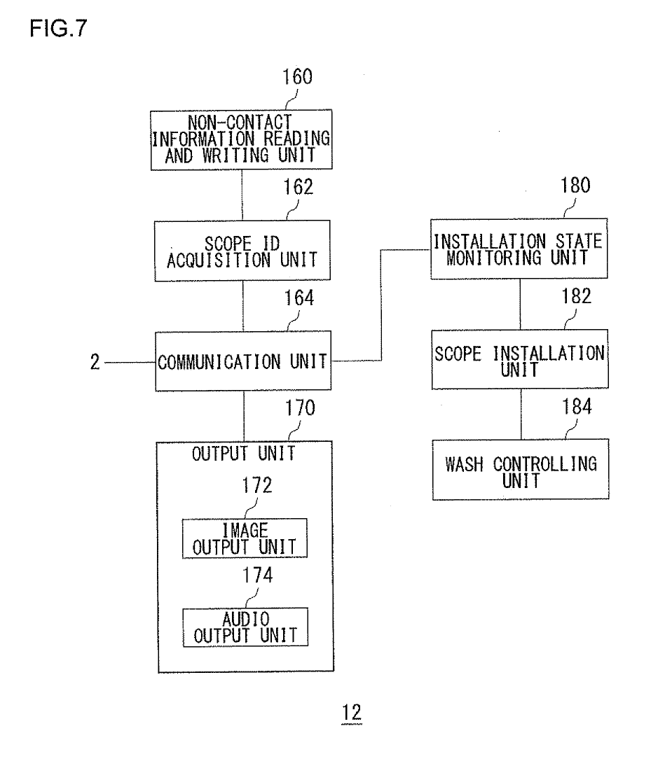

FIG. 7 shows the internal configuration of a washing device 12. The washing device 12 is provided with a non-contact information reading and writing unit 160, a scope ID acquisition unit 162, a communication unit 164, an output unit 170, an installation state monitoring unit 180, a scope installation unit 182, and a wash controlling unit 184.

The non-contact information reading and writing unit 160 is a non-contact information reading means which reads the identification information recorded in the memory of the endoscope. The non-contact information reading and writing unit 160 reads the identification information from the RFID tag of the endoscope by an electromagnetic induction method or an electric wave method. The non-contact information reading and writing unit 160 may be an optical reader which reads two-dimensional codes attached to the surface of the endoscope. For example, when a nurse brings an endoscope close to the non-contact information reading and writing unit 160, the non-contact information reading and writing unit 160 can read the identification information. The scope ID acquisition unit 162 acquires the identification information (scope ID) read from non-contact information reading and writing unit 160, and the communication unit 164 sends the scope ID to the information management device 100.

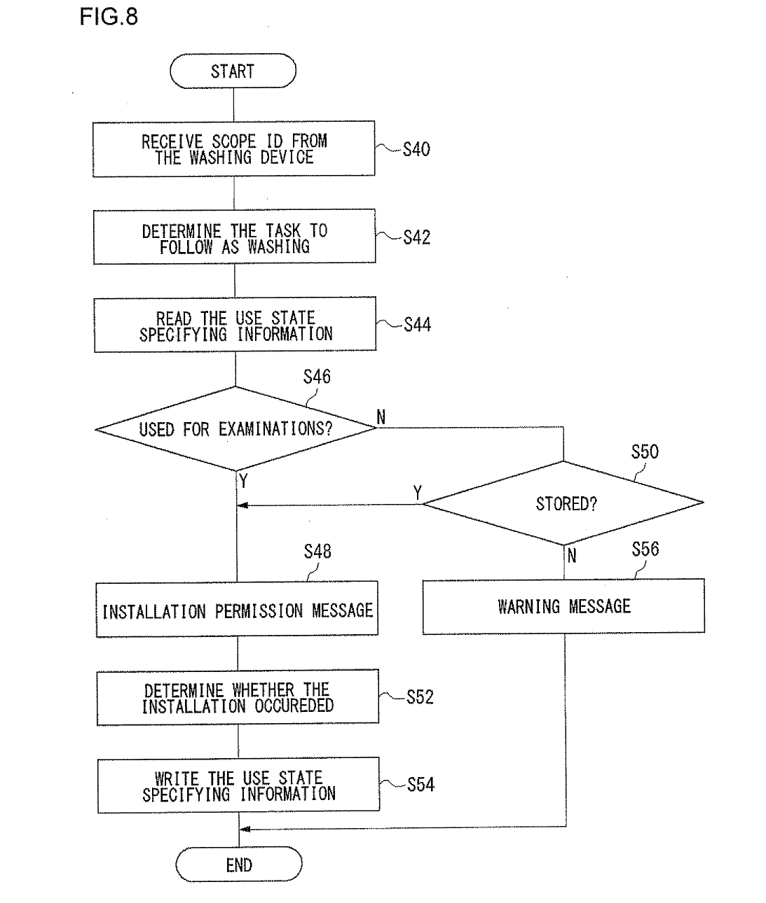

FIG. 8 is a flowchart showing a process of determining the properness of task execution by the information management device 100 prior to the installation of an endoscope on a washing device 12 by medical practitioners. The communication unit 102 receives the scope ID from the washing device 12 by referring to FIG. 3 (S40). The determination unit 114 determines that the endoscope is to be used for washing process as the scope ID is received from the washing device 12 (S42). The determination unit 114 learns that the current use state needs to be “used for examinations” or “stored” for the installation of a scope on the washing device 12 in accordance with the task execution table retained in the task flow memory unit 112. The reading unit 106 reads the use state specifying information recorded in relation with the scope ID from the use state specifying information recording unit 110 (S44).

When the use state specifying information read is “used for examinations” (Y in S46), and when the use state specifying information read is not “used for examinations” (N in S46) but “stored” (Y in S50), the determination unit 114 generates an installation permission message (S48) and sends the message to the communication unit 164 in the washing device 12 through the communication unit 102. On the other hand, if the use state of the endoscope is not “stored” (N in S50), the determination unit 114 generates a warning message (S56) and sends the message to the communication unit 164 in the washing device 12 through the communication unit 102.

Referring to FIG. 7, the communication unit 164 provides a message sent from the communication unit 102 to the output unit 170 and the output unit 170 outputs the message. In the output unit 170, an image output unit 172 may display the message on a display unit and an audio output unit 174 may output the message through a speaker. When the installation permission massage is confirmed, a medical practitioner installs the endoscope on the scope installation unit 182, and when the warning message is confirmed, the medical practitioner calls off the installation of the endoscope on the scope installation unit 182, being aware that there is a trouble caused in the use state management. In this manner, by managing the use state in accordance with the endoscopic examination operation flow, a situation can be avoided in which already washed endoscopes are washed repeatedly without noticing.

If an endoscope is installed on the scope placement unit 182, the installation state monitoring unit 180 learns that the installation has occurred (S52) and the communication unit 164 sends the information that specifies the installation to the communication unit 102. The writing unit 108 writes the use state specifying information in the use state specifying information recording unit 110 (S54). In this manner, the use state specifying information recording unit 110 becomes capable of retaining the latest use state specifying information “in washing process”. If only the latest use state specifying information needs to be retained, the use state specifying information may be overwritten. Especially, since the washing process of the endoscope is time consuming, the efficient use of the endoscope becomes possible by avoiding repeated washing.

After the washing preparation is completed, the wash controlling unit 184 performs the process of washing the endoscope in accordance with the predetermined washing program. There are a variety of types in endoscopes such as scopes for upper or lower endoscopy based on the patients' areas to be examined, and the washing program that is suitable to the scope type is performed.

When the installation state monitoring unit 180 detects that the endoscope is removed from the scope placement unit 182 after the washing process is completed, the communication unit 164 sends the information which specifies the removal of the scope to the communication unit 102. The writing unit 108 writes the use state specifying information in the use state specifying information recording unit 110. With this, the use state of the endoscope is changed to “already washed”. The data which specifies the washing date as a use state specifying information is also written at this time.

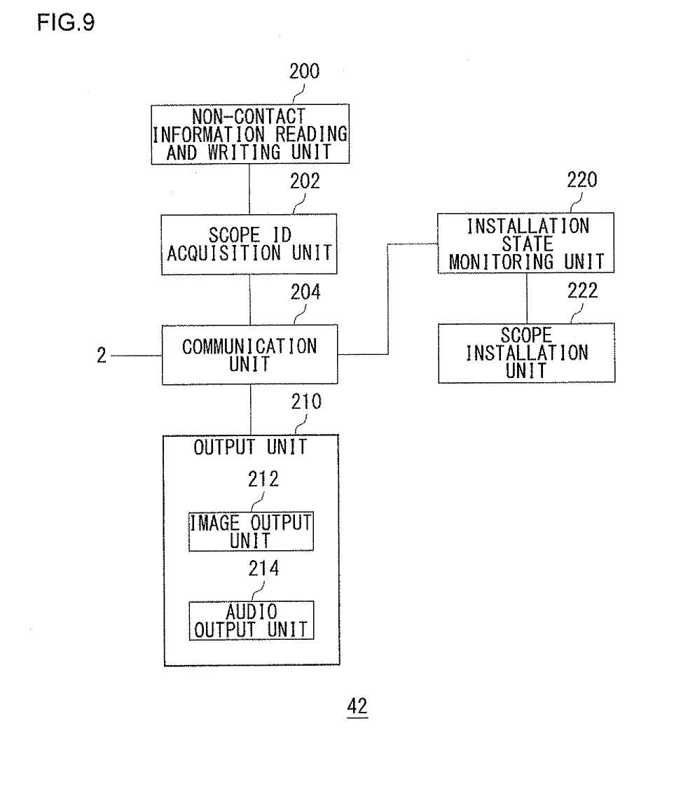

FIG. 9 shows the internal configuration of the storage management device 42. The storage management device 42 is provided with a non-contact information reading and writing unit 200, a scope ID acquisition unit 202, a communication unit 204, an output unit 210, an installation state monitoring unit 220, and a scope installation unit 222.

The non-contact information reading and writing unit 200 is a non-contact information reading means which reads the identification information recorded in the memory of the endoscope. The non-contact information reading and writing unit 200 reads the identification information from the RFID tag of the endoscope by an electromagnetic induction method or an electric wave method. The non-contact information reading and writing unit 200 may be an optical reader which reads two-dimensional codes attached to the surface of the endoscope. For example, when a nurse brings an endoscope close to the non-contact information reading and writing unit 200, the non-contact information reading and writing unit 200 can read the identification information. The scope ID acquisition unit 202 acquires the identification information (scope ID) read from non-contact information reading and writing unit 200, and the communication unit 204 sends the scope ID to the information management device 100.

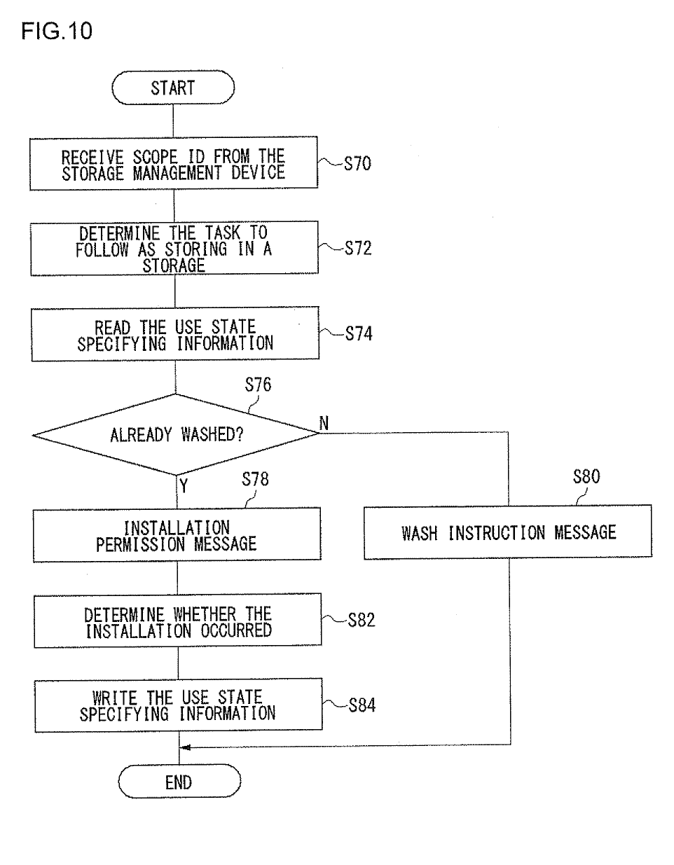

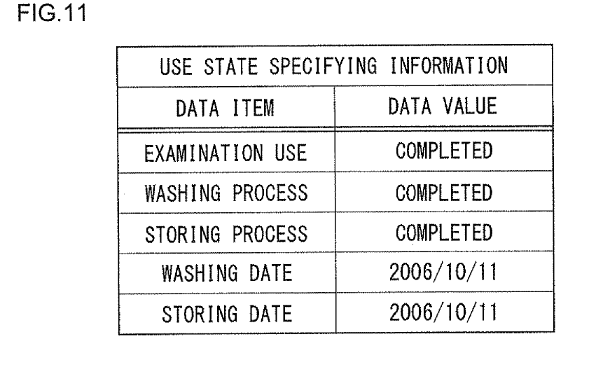

FIG. 10 is a flowchart showing a process of determining the properness of task execution by the information management device 100 prior to the storing of an endoscopic scope in the scope storage 40 by medical practitioners. Referring to FIG. 3, the communication unit 102 receives the scope IDs from the storage management device 42 (S70). The determination unit 114 determines that the endoscope is to be stored in the storage 40 as the scope ID is received from the storage management device 42 (S72). The determination unit 114 learns that the current use state needs to be “already washed” for the storing of a scope in the scope storage 40 in accordance with the task execution table retained in the task flow memory unit 112. The reading unit 106 reads the use state specifying information recorded in relation with the scope ID from the use state specifying information recording unit 110 (S74).

When the use state specifying information read is “already washed” (Y in S76), the determination unit 114 generates an installation permission message (S78) and sends the message to the communication unit 204 in the storage management device 42 through the communication unit 102. On the other hand, if the use state of the endoscopic scope is not “already washed” (N in S76), the determination unit 114 generates a wash instruction message (S80) and sends the message to the communication unit 204 in the storage management device 42 through the communication unit 102.

Referring to FIG. 9, the communication unit 204 provides a message sent from the communication unit 102 to the output unit 210 and the output unit 210 outputs the message. In the output unit 210, an image output unit 212 may display the message on a display unit and an audio output unit 214 may output the message through a speaker. When the installation permission massage is confirmed, a medical practitioner installs the endoscope on the scope placement unit 222, and when the wash instruction message is confirmed, the medical practitioner calls off the installation of the endoscope on the scope installation unit 222, being aware of the need for the endoscope washing. In this manner, by managing the use state in accordance with the endoscopic examination operation flow, the situation can be avoided in which unwashed endoscopes are stored in the scope storage 40.

If an endoscope is installed on the scope installation unit 222, the installation state monitoring unit 220 learns that the installation has occurred (S82) and the communication unit 204 sends the information that specifies the installation to the communication unit 102. The writing unit 108 writes the use state specifying information in the use state specifying information recording unit 110 (S84). In this manner, the use state specifying information recording unit 110 becomes capable of retaining the latest use state specifying information. If only the latest use state specifying information needs to be retained, the use state specifying information may be overwritten. With this, the use state of the endoscope is changed to “stored”. The data which specifies the storing date as a use state specifying information is also written in at this time.

FIG. 11 shows an example of the use state specifying information recorded in the use state specifying information recording unit 110. In this example, a series of tasks, from the examination to washing to storing, is considered as one cycle of the endoscopic examination operations and the data taken from the start of the examination to the storing in the storage is recorded. In the example in FIG. 11, the data at time of the completion of storing in the scope storage 40 is shown.

For example, when an endoscope stored in the storage 40 is about to be used with the endoscopic observation device 14 and the properness of the installation of the endoscope on the endoscopic observation device 14 is determined in accordance with the determination process shown in FIG. 6 and the endoscope is then actually installed, all the data value in the data format shown in FIG. 11 is set to NULL. When the examination with the endoscope is finished, only the data value in a data item “examination use” is changed to “completed” and the data values in the rest of the data items stay NULL. As described above, in a cycle of tasks, from the examination to storing in the storage, data value is written upon completion of each task. Thus, writing in the use state specifying information in the predetermined data format facilitates data management.

Although not shown in the figure, the use state information may include, for example, the patient ID assigned to the patient for whom the endoscope is used, and the ID assigned to the person in charge of performing the process of washing. For example, by performing a step of recognizing the ID assigned to the person in charge of performing the washing process, the washing process by an unauthorized person is prevented and the person who performed the washing process can be specified.

In the use state management in this embodiment, to determine the current use state of the endoscope from the last task performed is of importance. In the example in FIG. 11, the format is used in which data values are recorded for three data items, “examination use”, “washing process”, and “storing process”, respectively; however, the format may be the format in which only the current use state is recorded.

### EMBODIMENT 2

In the embodiment 1, the example is explained in which the endoscopic observation device 14, the washing device 12, and the storage management device 42, which are the task execution devices which execute respective tasks they are in charge of, have a function of reading the scope ID of the endoscope. In the embodiment 2, the PDA 30 in the possession of, for example, a nurse functions as reading means which read the scope ID in the medical service support system 1.

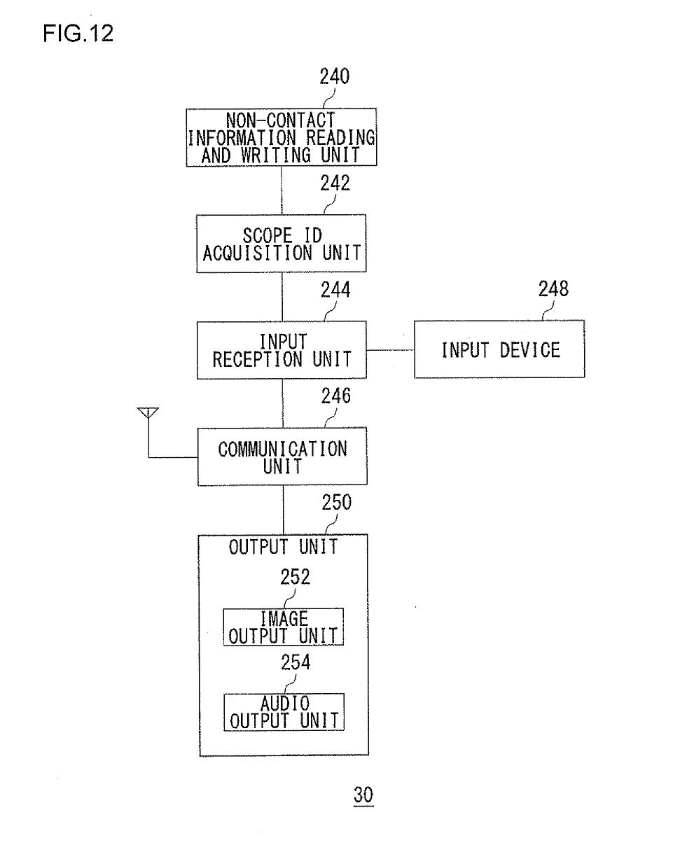

FIG. 12 shows an internal configuration of the PDA 30 according to the embodiment 2. The PDA 30 is composed of a non-contact information reading and writing unit 240, a scope ID acquisition unit 242, an input reception unit 244, a communication unit 246, an input device 248, and an output unit 250.

The non-contact information reading and writing unit 240 is a non-contact information reading means, which reads the identification information, recorded in the memory of the endoscope. The non-contact information reading and writing unit 240 reads the identification information from the RFID tag of the endoscope by an electromagnetic induction method or an electric wave method. The non-contact information reading and writing unit 240 may be an optical reader which reads two-dimensional codes attached to the surface of the endoscope. The scope ID acquisition unit 242 acquires the identification information (scope ID) read from non-contact information reading and writing unit 240.

The input reception unit 244 receives the input from the input device 248 manipulated by a nurse and so forth. The input device 248 is an input means such as keyboards, operation buttons, and touch panels. When the scope ID acquisition unit 242 acquires the scope ID, the image output unit 252 outputs the image to a display unit prompting the input of the name of the task about to be performed. A nurse inputs the use state of the task about to be performed as either “examination”, “washing”, or “storing” using the input device 248, and the input reception unit 244 receives the input. The image output unit 252 may display a box for text input of task names or display a list of task names in a selectable pull down format. As described above, when the input reception unit 244 receives the information of the task to be performed, the communication unit 246 sends the scope ID and information of the next task input by a nurse to the information management device 100.

The information management device 100 enables the use states management explained in the embodiment 1 by acquiring the scope ID and information of the next task from the PDA 30. That is to say, in the embodiment 1, the determination unit 114 determines the next task to be performed from the sender of the scope ID; meanwhile, in the embodiment 2, the process of specifying the next task to be performed is omitted since the information specifying the next task is sent from the PDA 30 with the scope ID. When the determination unit 114 sends a message based on the determination result to the PDA 30, the image output unit 252 outputs the message through the display unit and the audio output unit 254 outputs the message through a speaker, enabling a nurse in charge to know right away whether he/she can proceed to the next task, and thus resulting in smooth endoscopic examination operations.

### EMBODIMENT 3

In the embodiments 1 and 2, the medical service support system 1 is explained in which the information management device 100 manages the use state of the endoscope in an integrated manner. In the embodiment 3, the medical service support system 1 is shown in which the endoscopic observation device 14, the washing device 12, and the storage management device 42, which function as task execution devices, each has a function of determining the properness of task execution. In the medical service support system 1 in the embodiment 3, the endoscope has recording means which record the use state specifying information which specify the scope's use state.

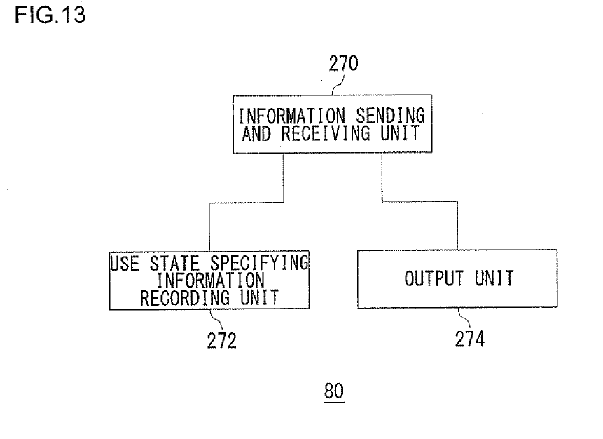

FIG. 13 shows the internal configuration of an endoscope 80. The endoscope 80 is composed of an information sending and receiving unit 270, a use state specifying information recording unit 272, and an output unit 274. The endoscope 80 is provided with an image capturing unit located at the tip and an actuator which controls the direction of the image capturing unit in accordance with the manipulation direction by doctors; however, FIG. 13 shows only the configuration necessary for use state management.

The information sending and receiving unit 270 is an information reading and writing means in which the information recorded in the use state specifying information recording unit 272 is read and sent, and the information from the task execution device is received and written into the use state specifying information recording unit 272. The use state specifying information recording unit 272 may record the use state specifying information in the same format as the use state specifying information recording unit 110. The recording format is as explained in FIG. 11. In the use state specifying information recording unit 110, it is necessary to record the use state specifying information on a plurality of endoscopes; however, in the use state specifying information recording unit 272, only its own use state specifying information is required to be recorded and thus, the memory capacity may be small comparatively. The information sending and receiving unit 270 and the use state specifying information recording unit 272 may be configured passive IC tags and have a function of allowing information from the use state specifying information recording unit 272 to be read by a reading signal from a RF reader installed in the task execution device, and writing information in the use state specifying information recording unit 272 by a writing signal from a RF reader. The output unit 274 displays or outputs audibly the messages provided from the task execution means.

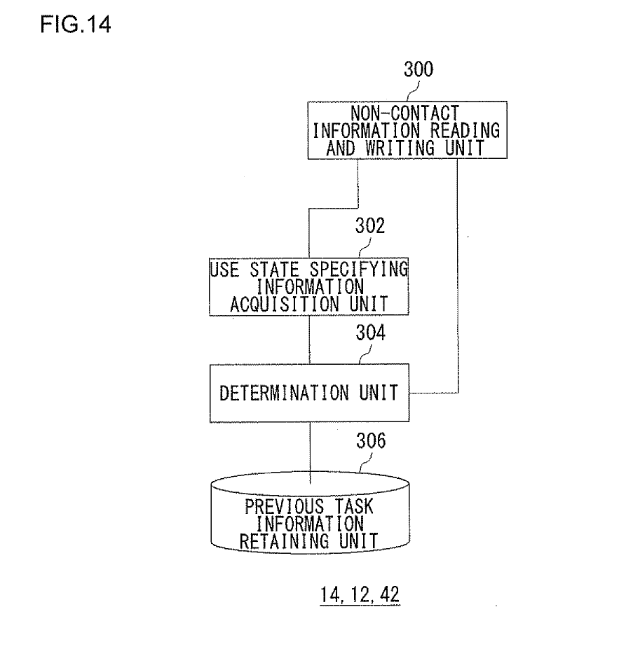

FIG. 14 shows an internal configuration of an endoscopic observation device 14, a washing device 12, and a storage management device 42 according to the embodiment 3. The endoscopic observation device 14, the washing device 12, and the storage management device 42 are respectively provided with a non-contact information reading and writing unit 300, a use state specifying information acquisition unit 302, a determination unit 304 and a previous task information retaining unit 306. FIG. 14 shows a configuration to determine the properness of task execution in each task execution device, and the configuration (task execution means) to perform the task of which each device is in charge is omitted. The basic configuration of the use state management is same in each task execution device; therefore, the endoscopic observation device 14 as an example is described in details in the following paragraphs.

The non-contact information reading and writing unit 300 sends and receives desired information to and from the information sending and receiving unit 270. The information sending and receiving unit 270 may be a passive IC tag and the non-contact information reading and writing unit 300 may be a RF tag reader.

When the non-contact information reading and writing unit 300 reads use state specifying information from the endoscope 80, the use state specifying information acquisition unit 302 acquires the use state specifying information. The previous task information retaining unit 306 retains information related to the tasks which are required to be executed already before the endoscopic examination performed by the endoscopic observation device 14. The information related to the use state is retained in which the endoscope 80 needs to be before the endoscopic examinations are performed. Specifically, the information which indicates that the use state needs to be either “already washed” or “stored” is retained.

The determination unit 304 determines whether the use of the endoscope for the examination follows the task sequence, in accordance with the use state specifying information acquired from the use state specifying information acquisition unit 302. Based on the use state specifying information retained in the previous task information retaining unit 306, the determination unit 304 determines whether the use state specifying information acquired indicates that the examination is to be performed. Specifically, if the current use state acquired from the use state specifying information acquisition unit 302 is either “already washed” or “stored”, the determination unit 304 determines that the endoscopic examination can be performed. Thus, in the determination unit 304, by allowing the performance of endoscopic examination when the use state specifying information acquired is information which shows the completion of the task which needs to be executed before the endoscopic examination, the endoscopic examination can be performed in a predetermined sequence. The determination unit 304 sends the permission message permitting the installation of the endoscope 80 from the non-contact information reading and writing unit 300 to the information sending and receiving unit 270. The information sending and receiving unit 270 may output the installation permission message from the output unit 274.

The determination unit 304 may also send information which specifies that the installation will be performed along with the installation permission message. At this stage, the endoscope 80 is not yet installed on the endoscopic observation device 14; however, since a nurse who receives the installation permission message will certainly install the endoscope 80 on the endoscopic observation device 14 on the moment, the use state specifying information which indicates the installation of the endoscope 80 may be sent to the information sending and receiving unit 270, and the use state specifying information in the use state specifying information recording unit 272 may be written by the information sending and receiving unit 270. In this manner, the use state specifying information recording unit 272 is capable of retaining the latest use state specifying information. If only the latest use state specifying information needs to be retained, the use state specifying information may be overwritten.

The determination unit 304 determines that the endoscopic examination should not be performed if the current use state is neither “already washed” nor “stored”. As explained in relation to FIG. 6, since the endoscope 80 is in need of washing in this case, the determination unit 304 sends the wash instruction message which instructs the endoscope 80 to be washed from the non-contact information reading and writing unit 300 to the information sending and receiving unit 270.

Described above is the case in which the endoscopic observation device 14 has the configuration shown in FIG. 14, and as stated previously, the same explanation/description applies to the case of the washing device 12 and the storage management device 42. The difference lies in that the previous task information retained in the previous task information retaining unit 306 varies for respective task execution devices; however, the processes in the non-contact information reading and writing unit 300, the use state specifying information acquisition unit 302, and the determination unit 304 are the same. Specifically, in the washing device 12, the previous task information retaining unit 306 retains the use states “used for examinations” and “stored” as the previous task information, and in the storage management device 42, the previous task information retaining unit 306 retains the use state “already washed” as the previous task information. In each task execution device, the properness of task execution is determined based on the previous task information of each device.

As described above, with the use state specifying information retained in the endoscope 80, there is no need for the information management device 100 to manage use state resulting in easier management of the use state. Since the latest use state is held in the endoscope 80 itself, a nurse can acquire the latest use state easily using the PDA 30. Also, even in a case in which, for example, the endoscope 80 is taken outside of a hospital, the information can be used easily outside of the hospital with the use state specifying information retained in the endoscope 80.

While in the embodiments 1-3, the endoscope 80 retains its own use state specifying information in its memory, additional useful information can also be retained in this memory.

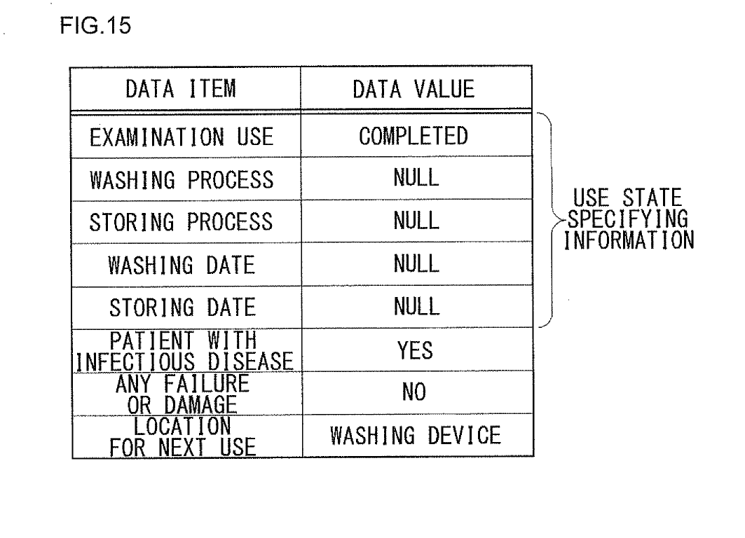

FIG. 15 shows an example of information recorded in the memory of the endoscope 80. The data values for specification of the use state are written in the data items, “examination use”, “washing process”, “storing process”, “washing date”, and “storing date”. In the example in FIG. 15, in addition to the use state specifying information, information which specifies “patient with infectious disease?”, “any failure or damage?”, and “location for next use” is recorded in the memory of the endoscope 80.

In the embodiments 1-3, the endoscopic examinations are performed in the endoscopic observation device 14 based on examination orders including the patient IDs. If a patient has an infectious disease, information on the infectious disease is linked to the patient's ID. Since the information on infectious diseases is displayed on the image output unit 132 and such, doctors and nurses who witness the examinations learn that the patient has infectious disease. However, since a nurse who is to wash the used endoscope 80 after the examination may not be the one who witnessed the examination, the endoscope 80 needs to inform the nurse that the endoscope 80 is used for a patient with an infectious disease.

For this reason, the endoscopic observation device 14 writes information which indicates whether the patient has infectious disease or not in the memory of endoscope 80 (the use state specifying information recording unit 272). The output unit 274 of the endoscope 80 displays on the display unit or outputs through a speaker indicating that the endoscope 80 was used for the patient with infectious disease after the endoscope 80 is removed from the endoscopic observation device 14. With this, a nurse who is in charge of washing can learn that the endoscope 80 is used for the patient with infectious disease and pay high-level attention to the handling of the endoscope 80.

Also, the endoscopic observation device 14 and the washing device 12 have a function of detecting any failure or damage of the endoscope 80. The endoscopic observation device 14 and the washing device 12 write any failure or damage in the use state specifying information recording unit 272 of the endoscope 80. Any failure or damage are displayed on the display unit or output through a speaker from the output unit 274. In this manner, a nurse does not forget to send the endoscope 80 to repair, avoiding a repeated use of the endoscope with some failure or damage.

Also, the endoscopic observation device 14, the washing device 12, and the storage management device 42 may write information which specifies the location where the endoscope 80 is to be used next in the use state specifying information recording unit 272. Since, for example, after the examination, the endoscope 80 needs to be washed, the endoscopic observation device 14 may write information which specifies that the endoscope 80 is about to be washed by the washing device 12 in the use state specifying information recording unit 272. Also, since the endoscope 80 will be stored in the scope storage 40 after washing, the washing device 12 may write information which specifies that the endoscope 80 is about to be taken to the scope storage 40 in the use state specifying information recording unit 272. Since the storage management device 42 can tell a name of the examination room where the endoscope 80 is about to be used as the storage management device 42 receives the examination order, the storage management device 42 may write information which specifies that the endoscope 80 is about to be taken to an examination room 10 in the use state specifying information recording unit 272. Thus, by recording the location where the endoscope 80 is intended to be used in the memory of endoscope 80, the output unit 274 can display or output the location audibly, enabling a nurse to know easily the location where the endoscope 80 needs to be taken to with the result that a smooth examination operation is achieved.

### EMBODIMENT 4

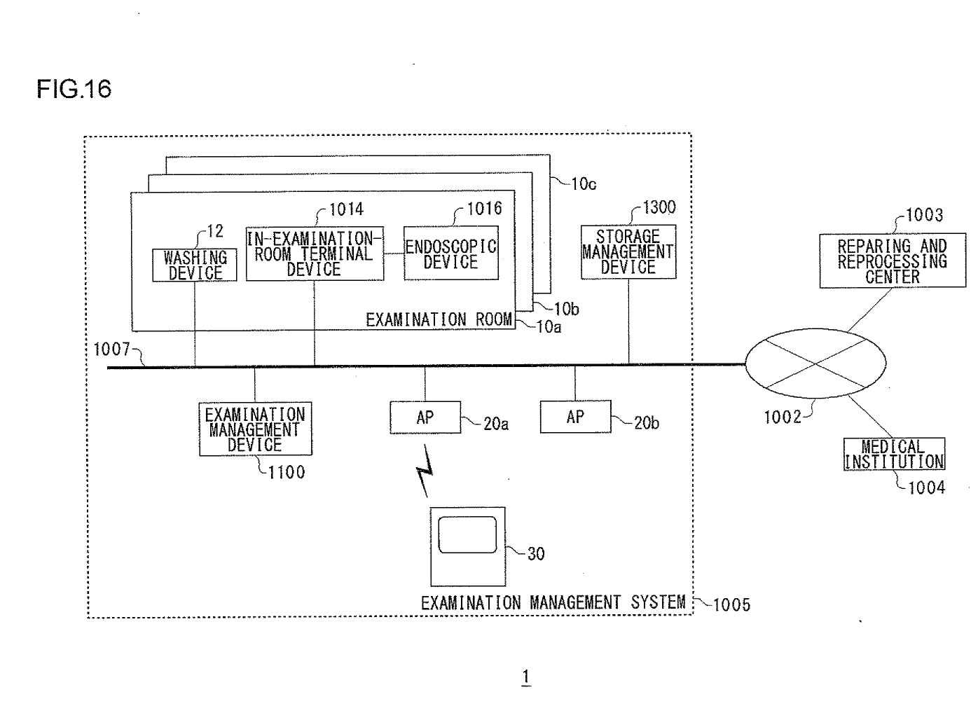

FIG. 16 shows a configuration of a medical service support system 1 according to the embodiment 4 of the present invention. The medical service support system has an examination management system 1005 which facilitates the smooth execution of examinations including the endoscopic examination. The examination management system 1005 is installed in medical institutions such as a hospital and the washing device 12, an in-examination-room terminal device 1014, the access points (AP) 20a and 20b, an examination management device 1100, and a storage management device 1300 are connected to a local area network (LAN) 1007 so that they can communicate with each other. The examination management system 1005 manages the status information which relates to the use state of the medical resources including the endoscope and the examination room.

The examination management system 1005 is connected to a repairing and reprocessing center 1003 and another medical institution 1004 through a network 1002 such as internet. The repairing and reprocessing center 1003 is an external institution where repairing and reprocessing of the medical instruments are conducted. The term reprocessing is defined as a process in which the medical instruments are disassembled, then utilizable parts are taken out, and finally medical instruments are reproduced.

In the medical service support system 1 in the embodiment 4, when the medical resources such as medical instruments are lent and borrowed between the medical institutions, the examination management system 1005 of the lender medical institution is given the information indicating the reception of medical resources by the borrower medical institution. With this, the examination management system 1005 manages the status of the medical resources as “out on loan” to another medical institutions. Also, when failed medical instruments are brought to the repairing and reprocessing center 1003, the examination management system 1005 of the medical institution is given the information indicating the reception of medical instruments by the repairing and reprocessing center 1003. With this, the examination management system 1005 manages the status of the medical resources as “out of order” or “under repair”. Thus, by being given the information on the medical resources with a connection to another external institution through the network 1002, the examination management system 1005 manages the status information of the medical resources taken outside.

The examination management system 1005 encompasses several examination rooms 10a, 10b, and 10c (hereinafter, generically referred to as “examination room 10”) to perform the endoscopic examination. Installed in each examination room 10 are an endoscopic device 1016 which the endoscope is to be connected to and an in-examination-room terminal device 1014 which displays the images captured by the endoscope on monitor and performs the saving process of the displayed images. The endoscopic device 1016 may have the same configuration as the endoscopic observation device 14 shown in the embodiments 1-3. Also, in each examination room 10, the washing device 12 which washes the used endoscope is installed. The washed endoscope is taken to the storage outside of the examination room and then the storage management device 1300 manages the storing state of the endoscope.

The examination management system 1005 is provided with an examination management device 1100 which manages the endoscopic examination in an integrated manner by managing the medical resources of the endoscopes and examination rooms. The examination management device 1100 has the function of determining the medical practice to be performed in accordance with the medical resources in a usable state by managing the status of the medical resources. Specifically, in the embodiment 4, the examination management device 1100 can determine the medical practice which can be performed in accordance with the status information of the endoscope in addition to the management of the information on the use state of the endoscope, that is to say, the status information of the endoscope, and the presentation of the latest status information to the medical practitioners.

The examination management system 1005 has a plurality of access points AP 20a and 20b (hereinafter, generically referred to as “AP 20”). A plurality of the AP 20s are installed in the hospital and in the examination room 10 so that the signal from PDA (Personal Digital Assistant) 30 is received. The PDA 30 is a portable terminal device carried by the medical practitioners such as nurses and can send and receive data to/from the AP 20.

In addition to the regular PDA features such as data input means using touch-panels, data input processing means such as a CPU, data memory means, and display means for processed data, the PDA 30 has built-in features such as a wireless LAN card which enables the wireless communication with the AP 20 through the wireless LAN, and reading means for reading the identification information assigned to patients and medical instruments. The reading means of the PDA 30 may be an optical reader which reads two- or three-dimensional identification codes optically, or a RF reader which reads the identification information through electric waves and electromagnetic waves from a RF (Radio Frequency) tag. When the identification information assigned to medical instruments is read by the PDA 30, an entry screen is displayed on a display unit to prompt the input of, for example, the status of the medical instruments, and a nurse inputs the status of the medical instruments. Therefore, in the embodiment 4, when a nurse reads the identification information assigned to an endoscopic scope using the PDA 30, a screen to inquire the use state is displayed on the display unit of the PDA 30 and the nurse inputs the status of the endoscope using the input means.

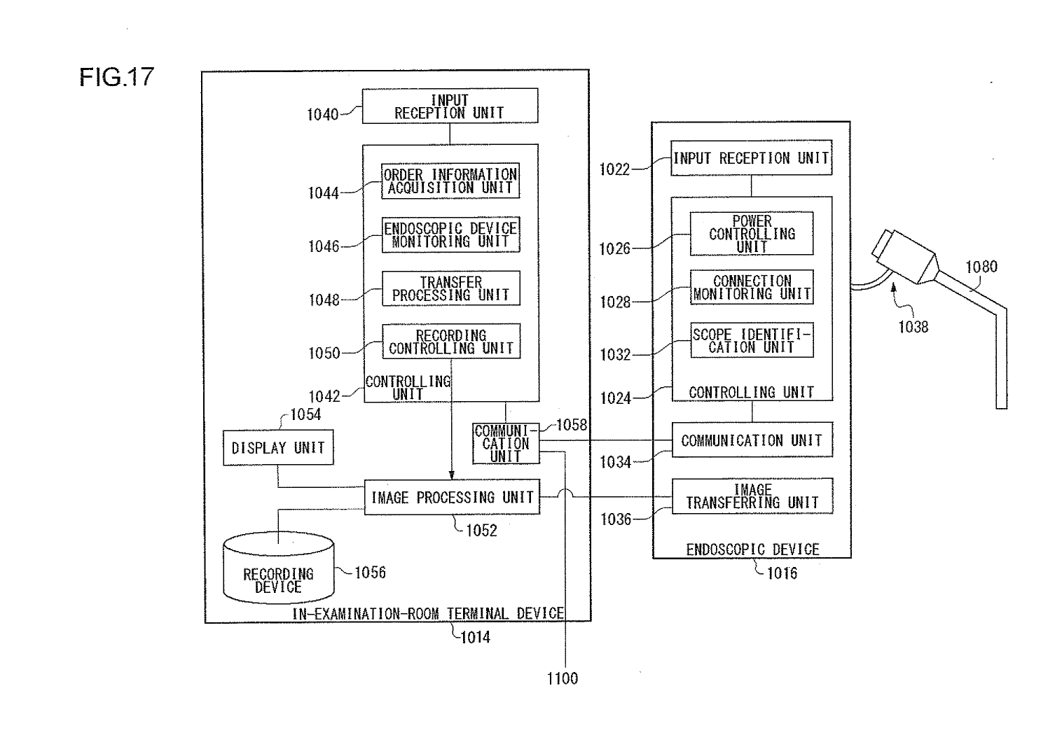

FIG. 17 is a view illustrating an internal configuration of the in-examination-room terminal device 1014 and the endoscopic device 1016 provided in an examination room. The in-examination-room terminal device 1014 is provided with an input reception unit 1040, a controlling unit 1042, an image processing unit 1052, a display unit 1054, a recording device 1056, and a communication unit 1058. The controlling unit 1042 is provided with an order information acquisition unit 1044, an endoscopic device monitoring unit 1046, a transfer processing unit 1048, and a recording controlling unit 1050. Also, the endoscopic device 1016 is provided with an input reception unit 1022, a controlling unit 1024, an image transferring unit 1036, and a communication unit 1034. The controlling unit 1242 is provided with a power controlling unit 1026, a connection monitoring unit 1028, and a scope identification unit 1032.

In the endoscopic device 1016, when the input reception unit 1022 receives pushing manipulation of a power button (not shown) by a medical practitioner, the power controlling unit 1026 provides power to the endoscopic device 1016. When the input reception unit 1022 is powered on and receives pushing manipulation of a power button by a medical practitioner, the power controlling unit 1026 terminates the power supply to the endoscopic device 1016. In order to finish the examination, the power controlling unit 1026 may terminate the power supply to an endoscope 1080 when the input reception unit 1022 receives pushing manipulation of an examination termination button (not shown) by a medical practitioner.

The connection monitoring unit 1028 monitors a connection state of the endoscope 1080 and the endoscopic device 1016. A connector 1038 is an instrument which connects to the endoscopic device 1016 electrically with a cable elongated out from the endoscope 1080. When the connection monitoring unit 1028 detects the connection of the connector 1038 to the endoscopic device 1016, the scope identification unit 1032 acquires the identification information of the endoscope 1080. As described previously, the endoscope 1080 retains the unique identification information to specify the endoscope 1080. This identification information may be retained in a built-in memory of the endoscope 1080 as a data code; therefore, with the endoscope 1080 connected to the endoscopic device 1016 in a way that the identification information can be read from the memory, the scope identification unit 1032 may read the identification information from the memory. The scope identification unit 1032 sends the acquired identification information to the communication unit 1034 and the communication unit 1034 sends the identification information to the communication unit 1058 in the in-examination-room terminal device 1014.

In the in-examination-room terminal device 1014, the order information acquisition unit 1044 acquires the order information of the endoscopic examination to be performed. The order information includes a patient ID, a reception time, an examination date, and an examination category. The order information is issued when a medical practitioner registers the examination details in a hospital reception terminal device upon the examination request of the patient at a reception desk in a hospital. In the examination management system 1005, the order information to be performed is provided to the order information acquisition unit 1044 from the examination management device 1100. The information included in the order information is displayed on the display unit 1054 so that the medical practitioner can confirm the information.

The endoscopic device monitoring unit 1046 monitors whether the examination room 10 is available. The endoscopic device monitoring unit 1046 may determine that the examination room 10 is available if, for example, the endoscopic device 1016 is powered off. Also, the endoscopic device monitoring unit 1046 may determine that the examination room 10 is available if, for example, nobody is on an examination bed. In this case, the endoscopic device monitoring unit 1046 may monitor the condition of the bed by the state of a pressure detecting means installed in the examination bed.

The endoscopic device monitoring unit 1046 may monitor the execution status of the endoscopic device 1016. When the endoscopic device 1016 is powered on and the connection of the endoscope 1080 is confirmed, the endoscopic device monitoring unit 1046 recognizes that the endoscopic device 1016 is ready for the examination. With this, the in-examination-room terminal device 1014 prepares to receive various data including the image data provided from the endoscopic device 1016 and the identification information of the endoscope. The endoscopic device monitoring unit 1046 may give warning from the display unit 1054 if the endoscope 1080 connected to the endoscopic device 1016 is determined not to match the examination category specified by the order information.

The transfer processing unit 1048 transfers the identification information of the endoscope 1080 received by the communication unit 1058 to the examination management device 1100 from the communication unit 1058. The examination management device 1100 can acquire the status information of the endoscope 1080 which is “in use” for the endoscopic examination by recognizing that the identification information is sent from the communication unit 1058. The communication unit 1058 may send the status information indicating that the endoscope is “in use” for the endoscopic examination along with the identification information.

When the examination preparations are completed, a doctor inserts the endoscope 1080 into a patient's body. The image transferring unit 1036 transfers the image data of the examined areas captured by the image capturing unit at the tip of the scope to the image processing unit 1052. The image processing unit 1052 converts the image data to a predetermined display format and outputs the data to the display unit 1054. With this, in the display unit 1054, the internal-body images captured are displayed in real time. The doctor manipulates the endoscope 1080 watching the internal-body images displayed on the display unit 1054 and when a release switch (not shown) of the endoscope 1080 is pushed, a pushing detecting signal is provided to the recording controlling unit 1050 from the communication unit 1034 and the recording controlling unit 1050 compresses and saves the image in a recording device 1056. In this manner, the desired image of, for example, an examined area can be saved in the recording device 1056 as a still image. The input reception unit 1040 receives the input from the input means such as a keyboard and a mouse. The input means is used to reprocess the image data in the recording device 1056 saved by a medical practitioner.

While in the endoscopic device 1016 shown in FIG. 17, the scope identification unit 1032 reads the identification information from the built-in memory of the endoscope 1080, the identification information may be attached to the endoscope 1080 as two-dimensional information and a nurse may read the attached identification information using the PDA 30. In this case, the nurse inputs the information indicating that the endoscope 1080 specified by the identification information will be used for the examination, and through the AP 20, the identification information of the endoscope 1080 and the status information indicating “in use” are sent to the examination management device 1100.

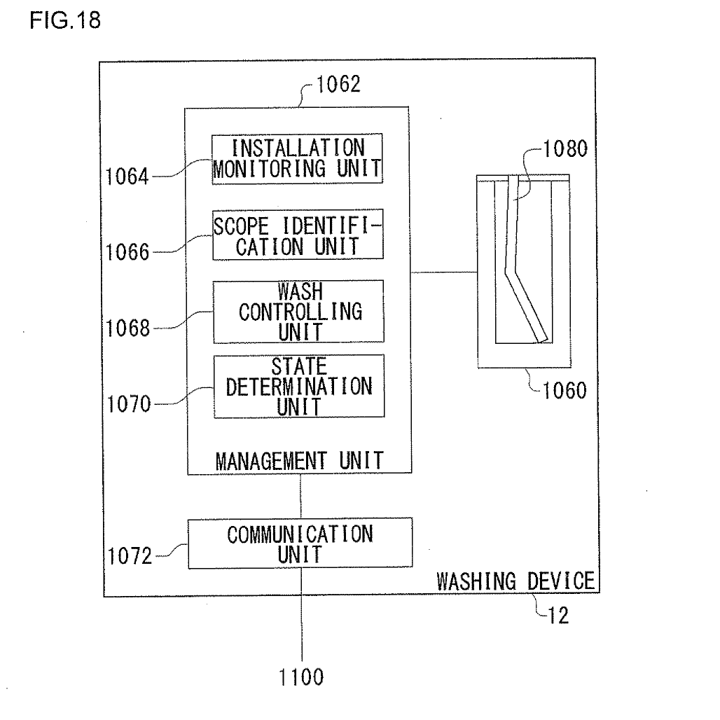

FIG. 18 shows an internal configuration of the washing device 12. The washing device 12 is provided with a wash tank 1060 to wash the endoscope 1080, a management unit 1062, and a communication unit 1072, and a management unit 1062 is provided with an installation monitoring unit 1064, a scope identification unit 1066, a wash controlling unit 1068, and a status determination unit 1070. The installation monitoring unit 1064 monitors whether the used endoscope 1080 is installed in the wash tank 1060. When the installation monitoring unit 1064 detects the installation in the wash tank 1060, the scope identification unit 1066 acquires the identification information of the endoscope 1080. The endoscope 1080 retains the identification information in its memory; therefore, the scope identification unit 1066 may read the identification information from the memory of the endoscope 1080, being connected to a connecting terminal of the wash tank 1060 in a way that the identification information can be read from the memory.

The wash controlling unit 1068 functions as the task execution means to execute the washing process of the endoscope 1080 by the wash tank 1060 in accordance with a predetermined washing program. There are a variety of types in the endoscope 1080 such as scopes for upper and lower endoscopy based on the patients' areas to be examined and the washing program that is suitable to the scope type is performed. When the washing task is performed by the wash controlling unit 1068, the status determination unit 1070 may create the status information of the endoscope 1080 in accordance with a progress of the washing task. Specifically, the status determination unit 1070 determines the status information at a different stage; the status information is determined to be “installed” at the stage when the endoscope 1080 is installed in the wash tank 1060; the status information is determined to be “being washed” when the washing is started by the wash controlling unit 1068; and the status information is determined to be “already washed” when the washing is completed by the wash controlling unit 1068 and the installation of the endoscope 1080 is detected by the installation monitoring unit 1064. Also, when the installation monitoring unit 1064 detects that the endoscope 1080 is removed from the wash tank 1060 after the completion of washing, the status determination unit 1070 determines that the endoscope 1080 is now in the “available” state. The communication unit 1072 sends the status information created by the status determination unit 1070 along with the identification information acquired by the scope identification unit 1066 to the examination management device 1100.

The identification information is attached to the endoscope 1080 as two-dimensional information and a nurse may read the identification information using the PDA 30. In this case, the nurse inputs the information indicating that the endoscope 1080 specified by the identification information is in a washing process, and the identification information of the endoscope 1080 and the status information indicating “being washed” are sent to the examination management device 1100 through the AP 20. The nurse may input in the PDA 30 the information that the endoscope 1080 specified by the identification information is in “available” state, after the completion of the washing process followed by the removal of the endoscope 1080 from the wash tank 1060. With this, the identification information of the endoscope 1080 and the status information indicating the endoscope 1080 is in “available” state are sent to the examination management device 1100 through the AP 20.

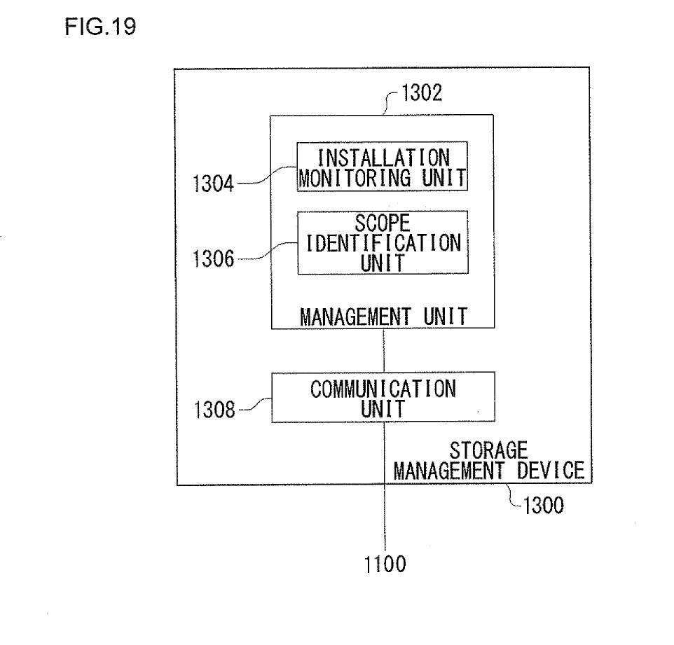

FIG. 19 shows an internal configuration of a storage management device 1300. The storage management device 1300 manages the identification information of the endoscope 1080 stored in the scope storage. Specifically, the storage management device 1300 is provided with a management unit 1302 and a communication unit 1308, and the management unit 1302 is provided with an installation monitoring unit 1304 and a scope identification unit 1306. In the storage, the endoscope is stored, being suspended from a suspension rack, and the endoscope is connected to a connecting terminal installed in the suspension rack so that the identification information can be read from the internal memory of the endoscope.

The installation monitoring unit 1304 monitors whether the endoscope is installed in the suspension rack in the storage. When the installation monitoring unit 1304 detects the installation of the endoscope in the suspension rack, the scope identification unit 1306 acquires the identification information of the endoscope by reading the identification information recorded in the memory of the endoscope. The communication unit 1308 sends the identification information acquired by the scope identification unit 1306 along with the status information indicating that the endoscope is in “stored” state in the storage to the examination management device 1100. The communication unit 1308 may send only the identification information acquired by the scope identification unit to the examination management device 1100.

If the identification information is attached to the endoscope as two-dimensional information, a nurse may read the identification information of the endoscope to be stored in the storage, using the PDA 30. In this case, the nurse inputs the information indicating that the endoscope specified by the identification information will be stored in the storage, and the identification information of the endoscope and the status information indicating the endoscope is in “stored” state may be sent to the examination management device 1100 through the AP 20.

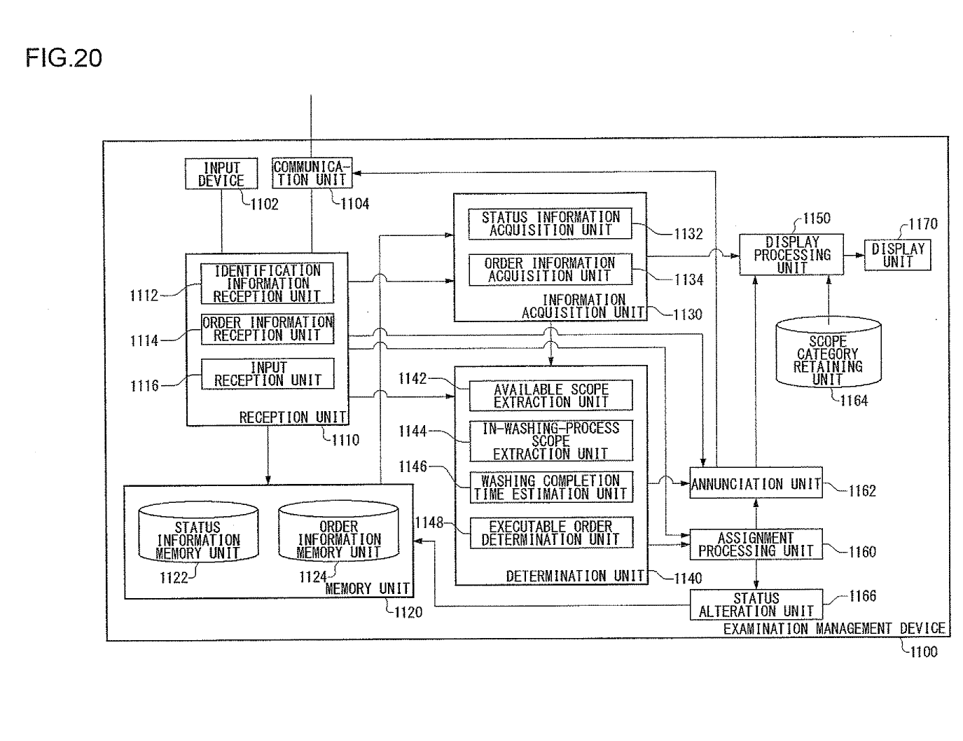

FIG. 20 shows an internal configuration of an examination management device 1100. The examination management device 1100 is provided with an input device 1102, a communication unit 1104, a reception unit 1110, a memory unit 1120, an information acquisition unit 1130, a determination unit 1140, a display processing unit 1150, an assignment processing unit 1160, an annunciation unit 1162, a scope category retaining unit 1164, a status alteration unit 1166, and a display unit 1170. The display unit 1170 is a monitor and displays information on the endoscopic examination. The input device 1102 is an input means, such as a mouse and a keyboard which enables the medical practitioner to input to a computer. The medical practitioner can perform an input operation as desired, by manipulating the input device 1102 while watching the information displayed on the display unit 1170.

The configuration is implemented in hardware by any CPU of a computer, a memory or other LSI's, and in software by a program or the like loaded into the memory. FIG. 3 depicts functional blocks implemented by the cooperation of hardware and software. Therefore, it will be obvious to those skilled in the art that the functional blocks may be implemented in a variety of manners by a combination of hardware and software.

The reception unit 1110 is provided with an identification information reception unit 1112, an order information reception unit 1114, and an input reception unit 1116. The identification information reception unit 1112 and the order information reception unit 1114 receive the information received in the communication unit 1104, and the input reception unit 1116 receives the input from the input device 1102 entered by the medical practitioner. The memory unit 1120 is provided with a status information memory unit 1122 and an order information memory unit 1124.

The identification information reception unit 1112 receives the identification information and the status information of the endoscope from the in-examination-room terminal device 1014, the washing device 12, and the storage management device 1300. The identification information reception unit 1112 may produce the status information from the information of the identification information source, and if that is the case, the identification information reception unit 1112 functions as a production means which produces the status information from the identification information. The status information memory unit 1122 stores the identification information and the status information received by the identification information reception unit 1112, mapping the identification information to the status information. When the identification information reception unit 1112 acquires the latest status information of the endoscope, the status information memory unit 1122 overwrites and stores the status information mapped to the identification information of the endoscope. As described above, in the status information memory unit 1122, the latest status information is kept stored, being mapped to the identification information of the endoscope.

Also, the status information memory unit 1122 stores not only the identification information of the endoscope and the status information, but also the status information of other medical resources. For example, the status information which indicates whether the examination room is available may be stored, and the status information of the medical resources for non-endoscopic examinations may also be stored.

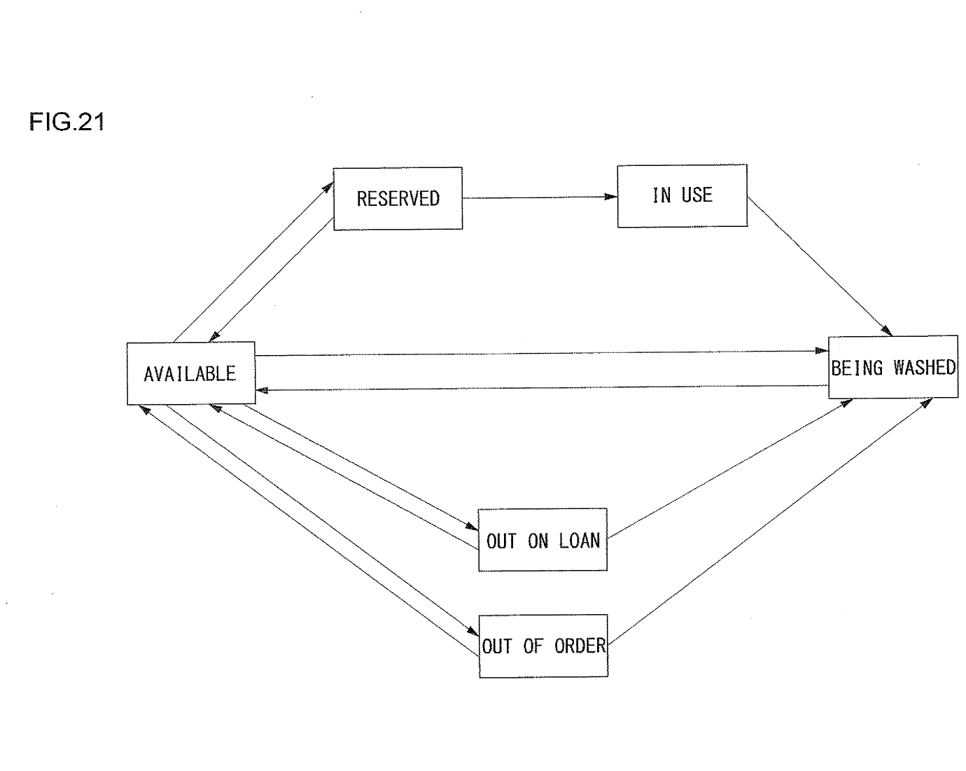

FIG. 21 is a diagram showing a transition in a status of the endoscope. In the medical service support system 1 in the embodiment 4, the endoscope can be roughly categorized into six statuses, “available”, “in use”, “being washed”, “out on loan”, “out of order”, and “reserved”.

The status, “available”, is the state in which the endoscope is already washed but not yet assigned to any examinations, and thus ready to be used right away. The endoscope in the “available” status is referred to as “scope available”. The endoscope stored in the storage is a scope available, and the endoscope taken out from the washing device 12 after the completion of the washing process is also a scope available.

Referring to FIG. 19, when the identification information reception unit 1112 receives the identification information from the communication unit 1308 located in the storage management device 1300, the identification information reception unit 1112 determines that the status information of the endoscope is “available” and stores the status information, mapping the status information to the status information memory unit 1122. Also, referring to FIG. 18, when the identification information reception unit 1112 receives the identification information of the endoscope and the status information “available” from the communication unit 1072 in the washing device 12, the identification information reception unit 1112 stores the identification information and the status information, mapping the identification information and the status information to the status information memory unit 1122. Also, when the identification information reception unit 1112 receives the identification information of the endoscope and the status information which indicates that the use state of the endoscope is “available”, the identification information reception unit 1112 stores the identification information received, mapping the identification information to the status information in the status information memory unit 1122.

The status “in use” indicates a state in which the endoscope is in use, being connected to the endoscopic device 1016. Referring to FIG. 17, when the identification information reception unit 1112 receives the identification information from the communication unit 1058 in the in-examination-room terminal device 1014, the identification information reception unit 1112 determines that the status information of the endoscope is “in use” and stores the status information, mapping the status information to the status information memory unit 1122. The identification information reception unit 1112 keeps the status “in use” without changing to “available” even when the endoscope is removed from the endoscopic device 1016. Also, when the identification information reception unit 1112 receives the identification information of the endoscope and the status information which indicates that the use state of the endoscope is “in use”, the identification information reception unit 1112 stores the identification information received, mapping the identification information to the status information in the status information memory unit 1122.

The status “being washed” indicates the state in which the endoscope is being washed while being connected to the washing device 12. As described previously, the status determination unit 1070 in the washing device 12 determines three statuses, “installed”, “being washed”, and “already washed” while the endoscope is installed in the wash tank 1060 and removed from the wash tank 1060, and in the example of FIG. 21, these three statuses are referred to as “being washed” altogether. Thus, when the identification information reception unit 1112 receives the identification information from the communication unit 1072 in the washing device 12 and the status information of either “installed”, “being washed”, or “already washed”, the identification information reception unit 1112 determines that the status information of the endoscope is “being washed” and stores the status information, mapping the status information to the status information memory unit 1122. Also, when the identification information reception unit 1112 receives, from the PDA 30, the identification information of the endoscope and the status information which indicates that the use state of the endoscope is either “installed”, “being washed”, or “already washed”, the identification information reception unit 1112 stores the identification information received, mapping the identification information to the status information “being washed” in the status information memory unit 1122. It is also possible to perform a status management with three divided statuses, “installed”, “being washed”, and “already washed”.

The status “out on loan” indicates the state in which the endoscope is out on loan to another medical institution 1004. The medical institution 1004, through the network 1002, sends the examination management system 1005 the identification information of the endoscope which is out on loan, and when the identification information reception unit 1112 receives the identification information from another medical institution 1004, the identification information reception unit 1112 determines that the status information of the endoscope is “out on loan” and stores the status information, mapping the status information to the status information memory unit 1122.

The status “out of order” indicates the state in which the endoscope is taken to the repairing and reprocessing center 1003. The repairing and reprocessing center 1003, through the network 1002, sends the examination management system 1005 the identification information of the endoscope for which repairing and reprocessing are requested, and when the identification information reception unit 1112 receives the identification information from the repairing and reprocessing center 1003, the identification information reception unit 1112 determines that the status information of the endoscope is “out of order” and stores the status information, mapping the status information to the status information memory unit 1122.

The status “reserved” indicates the state in which the endoscope is reserved for unperformed endoscopic examinations. The status “reserved”, as described later, is set when the determination unit 1140 determines the examination order which requires an available scope and the status alteration unit 1166 changes the “available” status to “reserved” status. The status alteration unit 1166 overwrites and updates the status information which has changed to “reserved” in the status information memory unit 1122, mapping the status information to the identification information. The endoscopic examination preparations are completed when a nurse connects the endoscope to the endoscopic device 1016 after he/she brings the endoscope whose identification information is set to “reserved” status and other instruments are all set. If the endoscope is connected to the endoscopic device 1016, the status changes from “reserved” to “in use”.

The order information reception unit 1114 receives the order information which is input from the hospital reception terminal and the input device 1102. The order information memory unit 1124 stores the order information received by the order information reception unit 1114. The order information includes a patient ID, a reception time, an examination date, and an examination category. The patient ID is an identification number to specify a patient uniquely, and the number is set by the hospital. The reception time is the time when a patient completes a reception for an examination after he/she applies for the examination, and the examination date is the date when the examination is performed, and if the examination is performed on the day, the examination date is same as the reception date. The examination category, in the case of endoscopic examinations, is the information which specifies the examination category to be performed, for example, the examination category specifies which endoscopic examination, the upper endoscopy or the lower endoscopy, needs to be performed.

The order information received at the order information reception unit 1114 is kept stored in the order information memory unit 1124 until the examination specified by the order is completed and payment of medical bill by a patient is confirmed. Thus, in the order information memory unit 1124, the order information of medical practices which are already performed and to be performed are stored, and the medical order of all kinds of examinations in addition to the medical order of the endoscopic examination, are also recorded.

The input reception unit 1116 receives manipulation input of the input device 1102 by a medical practitioner. For example, if the medical practitioner clicks a selectable button displayed on the display unit 1170, using a mouse, the input reception unit 1116 detects a pushing of the selectable button and notifies, for example, the information acquisition unit 1130 and the determination unit 1140 of the pushing as a command to start executing a desired process.

The information acquisition unit 1130 is provided with a status information acquisition unit 1132 and an order information acquisition unit 1134. Since the support for the efficient execution of the endoscopic examination is a goal in the medical service support system 1 in the embodiment 4, the status information acquisition unit 1132 acquires the status information of the endoscope and the status information of the endoscopic examination room from the status information memory unit 1122. For example, the status information memory unit 1122 may set flags for the status information of the endoscope and the status information of the endoscopic examination room, and the status information acquisition unit 1132 may extract the status information of the endoscope and the status information of the endoscopic examination room from several different types of status information by referring to the flags.

The order information acquisition unit 1134 extracts and acquires the order information on the endoscopic examination from the order information memory unit 1124. In the order information memory unit 1124, a flag indicating the completion of execution may be created for the order whose account needs to be closed after the examination is completed. The order information acquisition unit 1134, by referring to the presence or absence of the flag indicating the completion of execution, acquires the order information on the endoscopic examination which is not yet performed, more specifically, the endoscopic examination which is scheduled to be performed.

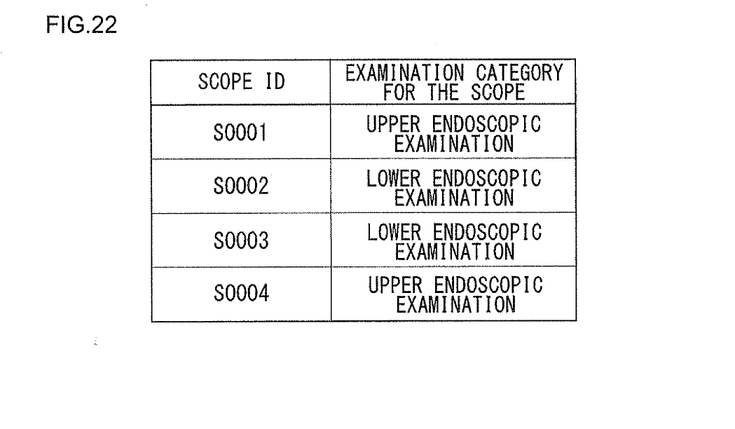

The scope category retaining unit 1164 retains a table storing the identification information of the endoscope in relation with the examination category for which the endoscope can be used. FIG. 22 indicates a table storing the identification number of the endoscope (scope ID) in relation with the examination category for which the endoscope can be used. In this table, the correspondence relation of all the endoscope managed in the examination management system 1005 is recorded. The example in FIG. 22 shows that the endoscopes assigned the IDs of S0001 and S0004 are used for the upper endoscopic examinations, and the endoscopes assigned the IDs of S0002 and S0003 are used for the lower endoscopic examinations.

The display processing unit 1150 receives the identification information and the status information both acquired by the status information acquisition unit 1132 and the order information acquired by the order information acquisition unit 1134, and produces the examination management screen to be displayed on the display unit 1170. The display processing unit 1150, by referring to the table retained in the scope category retaining unit 1164, reads the examination category for which the endoscope can be used from the identification number of the endoscope and uses the examination category as information for the examination management screen.

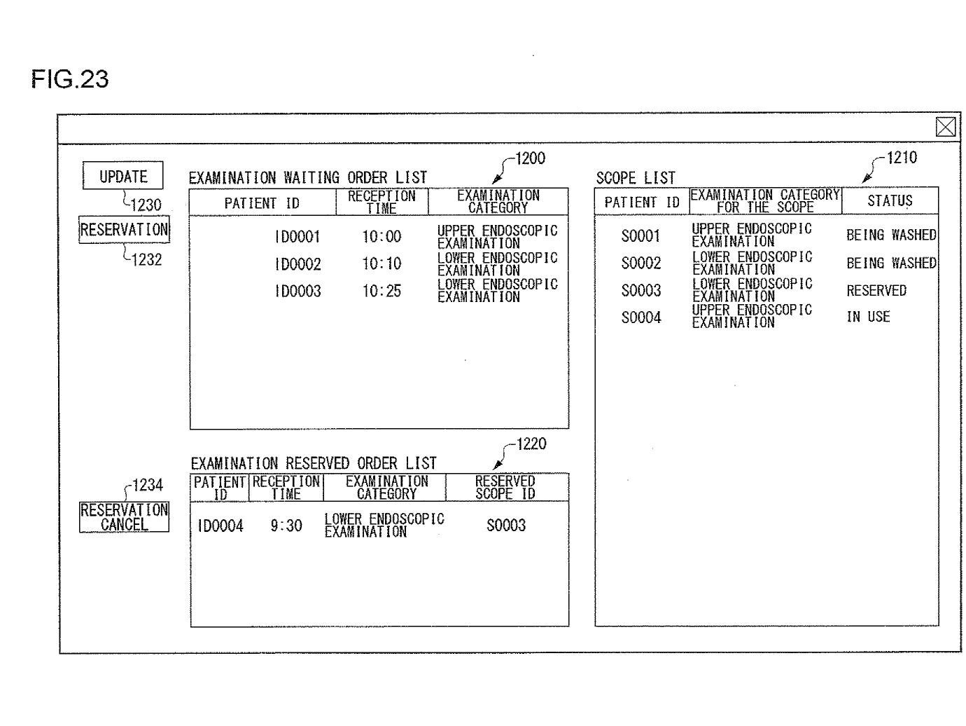

FIG. 23 shows an example of the examination management screen displayed on the display unit 1170. In the examination management screen, several display areas are set. Specifically, an examination waiting order list display area 1200, a scope list display area 1210, and an examination reserved order list display area 1220 are set.

On the examination waiting order list display area 1200, out of the unperformed endoscopic examination order acquired by the order information acquisition unit 1134, a list of the examination order with no endoscope reserved is displayed. On the examination waiting order list display area 1200, out of the order information, the patient ID, the reception time, and the examination category are displayed.

On the examination reserved order list display area 1220, out of the unperformed endoscopic examination orders acquired by the order information acquisition unit 1134, a list of the examination order with an endoscope reserved is displayed. On the examination reserved order list display area 1220, out of the order information, the patient ID, the reception time, and the examination category are displayed, and the reserved endoscope ID mapped to the examination order is also displayed.

On the scope list display area 1210, the status information of the endoscope acquired by the status information acquisition unit 1132; and an “examination category for the scope”, for which the endoscope can be used, retained in the scope category retaining unit 1164, are displayed, being mapped to the identification information of the endoscope.

In the examination management screen shown in FIG. 23, the endoscope of the scope ID, S0003, is reserved for the examination order for the patient ID, ID0004. As a result, in the a scope list display area 1210, the status of the endoscope S0003 is set to “reserved”, and in the examination reserved order list display area 1220, the endoscope S0003 is linked to the examination order with ID0004. A process of changing an examination waiting order to an examination reserved order is described in details in the following paragraphs, using the examination management screen shown in FIG. 23.

A determination unit 1140 is provided with an available scope extraction unit 1142, an in-washing-process scope extraction unit 1144, a washing completion time estimation unit 1146, and an executable order determination unit 1148. The available scope extraction unit 1142 extracts the available scope set to “available” from the status information of all the endoscope acquired by the status information acquisition unit 1132. As for the extraction timing by the available scope extraction unit 1142, it is preferable that the extraction is performed right after the latest status information is acquired by the status information acquisition unit 1142. The status information acquisition unit 1132 may acquire the latest status information from the status information memory unit 1122 when, for example, a nurse pushes an update button 1230, and the status information acquisition unit 1132 may also acquire the latest status information automatically in a predetermined time cycle such as a one minute cycle. The available scope extraction unit 1142 extracts an available scope by referring to the latest status information acquired. Since there is no scope available in the examination management screen in FIG. 23, the available scope extraction unit 1142 cannot extract any scopes available at the moment.

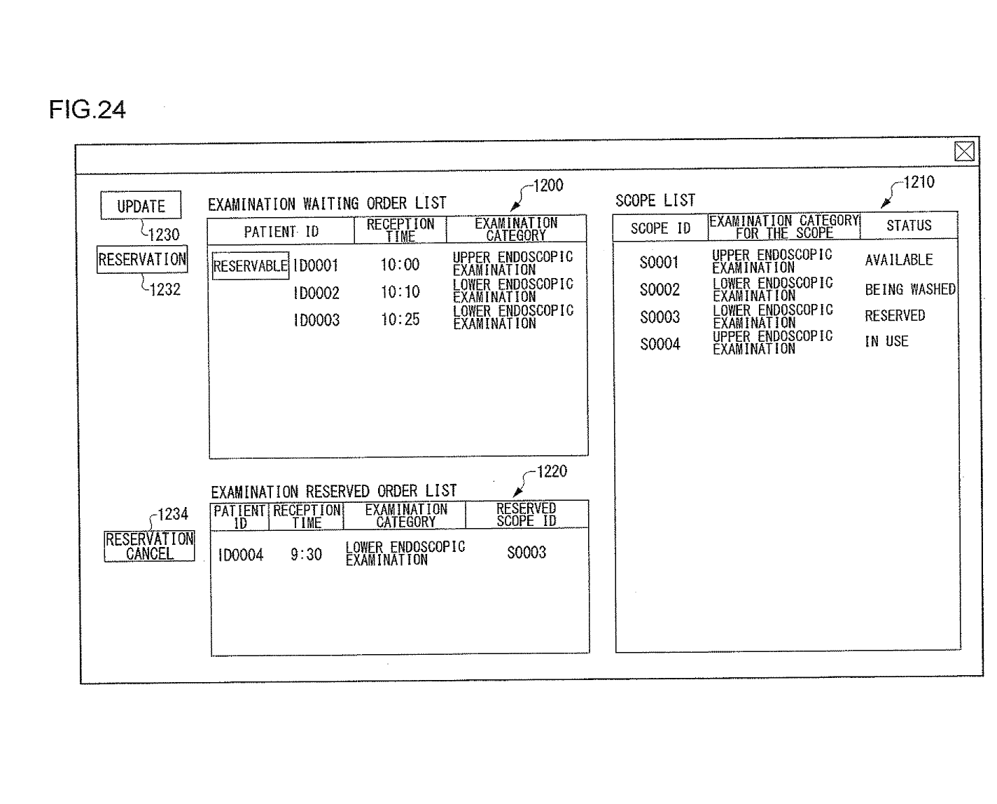

FIG. 24 shows an example of the examination management screen displayed on a display unit 1170. In this examination management screen, the status of the endoscope S0001 is updated to “available” in the scope list display area 1210. This update indicates that the washing process in the washing device 12 is completed and the endoscope is removed from the washing device 12. In this case, the available scope extraction unit 1142 extracts the endoscope S0001 as an available scope.

When the executable order determination unit 1148 receives the information on the available scopes from the available scope extraction unit 1142, the executable order determination unit 1148 determines, out of the examination waiting order, if there is an examination order for which the available endoscope can be used. Since the endoscope S0001 is a scope for the upper endoscopic examination, the executable order determination unit 1148 searches the examination waiting order for the examination order whose examination category is the upper endoscopic examination. In the example of FIG. 24, the examination category for the patient ID0001 is the upper endoscopic examination, and thus the executable order determination unit 1148 determines that the endoscope S0001 can be used for the patient ID0001 and concludes that this examination order is the order to be performed (executable order).

The annunciation unit 1162, when receives the executable order from the executable order determination unit 1148, processes to announce the medical practitioner that the order is executable. Specifically, as shown in the examination waiting order list display area 1200, the annunciation unit 1162 sends the examination order of the patient ID0001 an order for a mark “reservable” to be displayed. In this manner, the medical practitioner discovers that there is an endoscope available for the examination order to be executed and that the examination can be performed with the endoscope. When the medical practitioner pushes a reservation button 1232, the endoscope S0001 is reserved for the patient ID0001 and the endoscope S0001 is assigned to the examination for the patient ID0001.

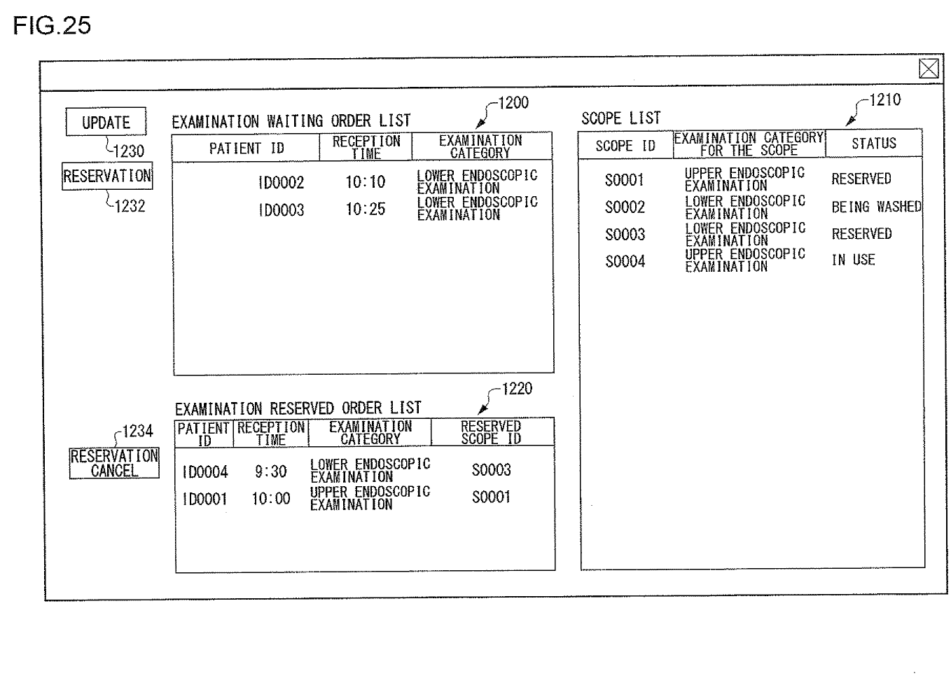

FIG. 25 shows an example of the examination management screen displayed on a display unit 1170. When the input reception unit 1116 receives the pushing of the reservation button 1232 by the medical practitioner, the assignment processing unit 1160 processes to reserve the endoscope. Specifically, the assignment processing unit 1160 assigns the endoscope S0001 to the examination order of the patient ID0001 and sends the display processing unit 1150 an order for the display location of the examination order to be moved to the examination reserved order list display area 1220 from the examination waiting order list display area 1200. In this manner, an available scope can be assigned and reserved for the examination order, and thus the failure to prepare the endoscope before the execution of the examination order can be prevented. If the assignment processing is performed, the status alteration unit 1166 changes the status of the available scope to the “reserved” status which indicates that the endoscope will be used for the endoscopic examination, and the status alteration unit 1166 also overwrites the status information of the status information memory unit 1122. Thus, the status information in the status information memory unit 1122 stays updated.

If the medical practitioner pushes a reservation cancel button 1234, the assignment processing unit 1160 cancels the reservation for the endoscope. For example, when the reservation cancel button is pushed, the assignment processing unit 1160 may cancel all the reservations for the examination orders displayed on the examination reserved order list display area 1220; also, the assignment processing unit 1160 may cancel the most recent reservation. If the reservation cancel button 1234 is pushed in the examination management screen shown in FIG. 25 and only the most recent reservation is canceled as the result, the examination management screen returns to the examination management screen shown in FIG. 24.

When the assignment processing is completed by the assignment processing unit 1160, the annunciation unit 1162 sends the nurse's PDA 30 a message which permits to start preparing for the endoscopic examination for which the endoscope is used.

After the announcement of the examination order to be executable, if the reservation button 1232 is not pushed and the assignment processing is not conducted by the assignment processing unit 1160 within a predetermined time, the annunciation unit 1162 announces warning information to the display unit 1170 or the PDA 30. With this, the medical practitioner can be prompted to reserve the endoscope, and thus the efficient endoscopic examination operation can be achieved.

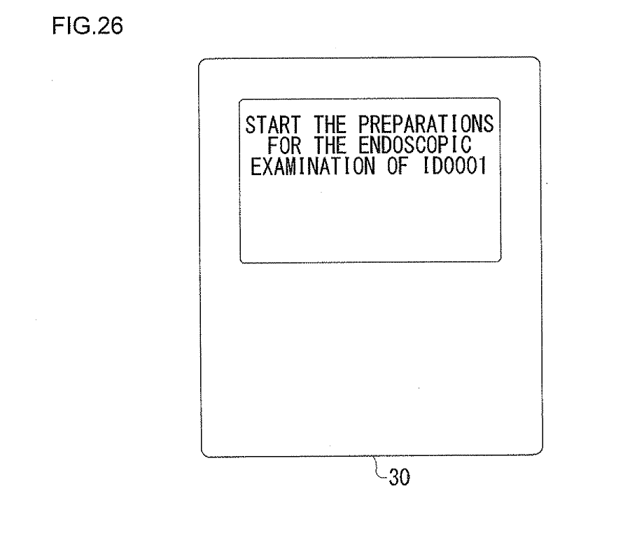

FIG. 26 shows an example of a message displayed on the PDA 30. A nurse, having received this message, takes the patient from his/her hospital ward to the examination room 10 and the endoscope S0001 to the examination room 10, and he/she starts preparing for the endoscopic examination. As described above, by sending the message to the PDA 30, the nurse is announced to start preparing for the examination, and the message may also be sent to other terminal devices at the same time.

The message sent to the nurse may include the room number of the examination room 10. In this manner, the nurse can know in which examination room he/she needs to prepare the instruments. For that purpose, the annunciation unit 1162 may receive the status information of an unoccupied room from the status information acquisition unit 1132 and include the room number of the unoccupied room in the message.

The available scope extraction unit 1142 may extract a scope available under the condition that there is an available room in the examination room. If there is no room available in the examination room 10, an endoscope may be reserved, but the endoscopic examination cannot be performed right away. For this reason, the available scope extraction unit 1142 acquires the status information of the examination room from the status information acquisition unit 1132 and performs an extraction process under the condition that there is an available room. In this case, the assignment processing unit 1160 may assign an available scope and also the examination room 10 in the available status to the examination order and specify the examination room 10 in which the examination is to be performed.

A nurse, when the preparations for the examination are completed, reports accordingly from the PDA 30. The reception unit 1110, having received the report indicating the completion of the examination preparations from the communication unit 1104, the annunciation unit 1162 sends a message indicating the completion of the examination preparations to the terminal device of a doctor in charge. In this case, it is preferable to send along the room number of the examination room 10. In this manner, the doctor can know to which examination room he/she needs to go.

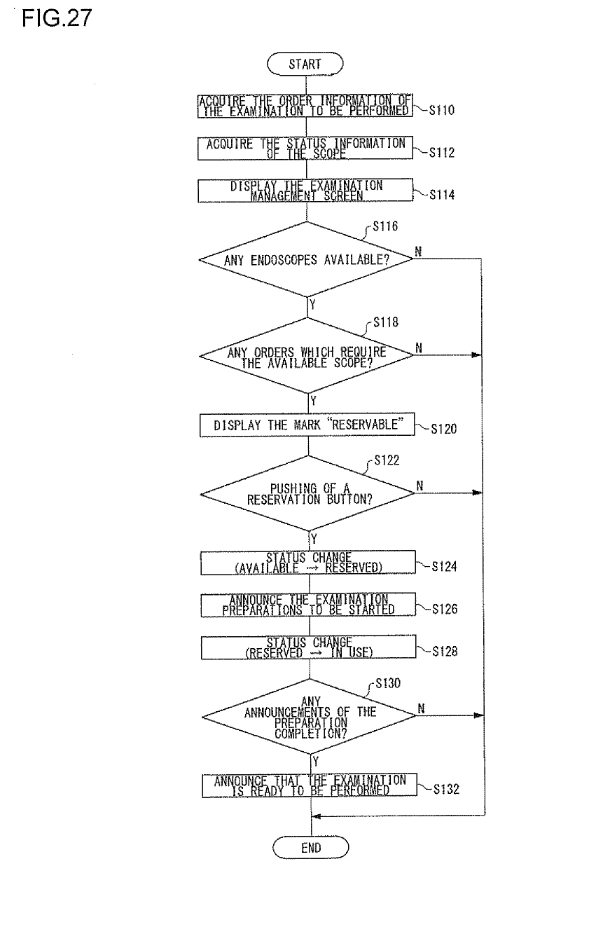

FIG. 27 shows a flowchart of the examination management process. In the examination management device 1100, the order information acquisition unit 1134 acquires the order information of the endoscopic examination to be performed from the order information memory unit 1124 (S110), and the status information acquisition unit 1132 acquires the status information of several endoscopes from the status information memory unit 1122 (S112). In this case, the status information acquisition unit 1132 may acquire the status information of the examination room. The display processing unit 1150 displays the examination management screen on the display unit 1170 based on the acquired order information and status information (S114).

The available scope extraction unit 1142, by referring to the status information, determines if there are any endoscopes available (S116). If there is no scope available (N in S116), the flow is completed. If there is a scope available (Y in S116), the executable order determination unit 1148 checks for compliance of the examination category included in the order information with the “examination category for the scope” to which the available scope is assigned and determines if there are any examination orders which require the available scope (S118). If there is no examination order which requires the available scope (N in S118), the flow is completed. On the other hand, if there is an examination order which requires the available scope (Y in S118), the annunciation unit 1162 informs the medical practitioner that the examination order is executable. Specifically, the annunciation unit 1162 sends an order for the mark “reservable” to be displayed on the display unit 1170 (S120).

If the input reception unit 1116 is on waiting for the reservation button 1232 to be pushed by a medical practitioner (S122), and if, for example, the reservation button is not pushed within a predetermined time after the mark, “reservable” is displayed, (N in S122), the annunciation unit 1162 may issue warning information to the medical practitioner. When the input reception unit 1116 receives the pushing of the reservation button 1232 (Y in S122), the assignment processing unit 1160 assigns an available scope to the examination order, and the status alteration unit 1166 changes the status of the scope available to “reserved” (S124). Also, the annunciation unit 1162 announces the medical practitioner that he/she can start preparing for the medical practice (S126).

Having received this announcement, for example, a nurse brings the endoscope to the examination room, connects the endoscope to the endoscopic device 1016 and prepares for the endoscopic examination. When the endoscope is connected to the endoscopic device 1016, the identification information is sent from the communication unit 1058 in the in-examination-room terminal device 1014. The identification information reception unit 1112, when receives the identification information of the endoscope, set the status to “in use” (S128) and overwrites the status information memory unit 1122.

When the preparations for the endoscopic examination are completed, a nurse announces the completion of the preparations to the examination management device 1100 from the PDA 30 (Y in S130). If there is no announcement of the completion of the examination preparations from the step of the status change in S128 within a predetermined time (N in S130), the flow is completed. The annunciation unit 1162, having received the announcement of the completion of the examination preparations, announces the doctor in charge that the endoscopic examination is ready to be performed (S132), and the flow is completed.

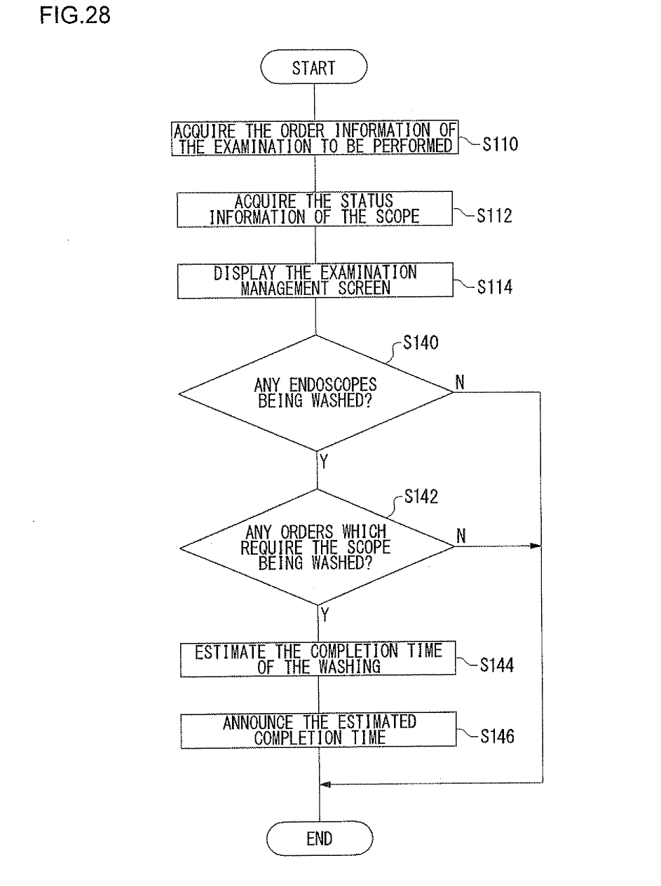

FIG. 28 shows a variation example of the examination management process flowchart. This variation example is characterized by the estimation of the time required for the washing process to be completed when the task is being performed to restore the endoscope to a usable state, that is to say, when the endoscope is being washed. Since the washing process is executed in a predetermined program by the wash controlling unit 1068, the time at which the washing process is to be completed can be estimated.

In the endoscopic examination, a previous treatment to anesthetize a patient is required. Since a certain amount of time is required for the anesthesia to become effective, if the patient is anesthetized after he/she is transferred to the examination room, the medical resources cannot be used effectively with some time wasted while waiting for the anesthesia to be effective. Thus, it is preferable, by estimating the completion time of the washing process, that the patient to be anesthetized ahead of time so that the anesthesia becomes effective by the time the washing process is completed.

In the examination management device 1100, the order information acquisition unit 1134 acquires the order information of the endoscopic examination to be performed from the order information memory unit 1124 (S110), and the status information acquisition unit 1132 acquires the status information of several endoscopes from the status information memory unit 1122 (S112). The display processing unit 1150 displays the examination management screen on the display unit 1170 based on the acquired order information and status information (S114).

The in-washing process scope extraction unit 1144, by referring to the status information, determines if there are any endoscopes being washed (S140). If there is no scope being washed (N in S140), then this flow is completed. If there is a scope being washed (Y in S140), the executable order determination unit 1148 checks for compliance of the examination category included in the order information with the “examination category for the scope” to which the scope being washed is assigned and determines if there are any examination orders which require the scope being washed (S142). If there is no examination order which requires the scope being washed (N in S142), then this flow is completed. On the other hand, if there is an examination order which requires the scope being washed (Y in S142), a washing completion time estimation unit 1146 estimates the time when the washing process is to be completed (S144). In the washing device 12, the wash controlling unit 1068 controls the washing process with a timer, and thus the completion time can be calculated. The washing completion time estimation unit 1146 acquires the completion time of the washing process from the wash controlling unit 1068 and sets the completion time as an estimated completion time. The annunciation unit 1162 notifies, for example, the PDA 30 of this estimated completion time (S146). With this, the medical practitioner can know the completion time of the washing process, and an efficient time management, for example, the time management for a previous treatment to be performed on a patient and the transportation of a patient to the examination room can be triggered.

In the embodiment 4, a case of the endoscopic examination is explained; however, the present invention can also be applied for other examinations and other surgical operations and treatments. Also, as described previously, in addition to the preparation task for the endoscope, for example, the time management for a previous treatment on a patient and the transportation of a patient to the examination room can be set in an efficient manner.

For example, the present invention can be applied to systems for operation rooms and for hospital wards and to a system linkage between operation rooms and hospital wards. Specifically, in the case of a patient to be transferred from his/her hospital ward to an operation room, a nurse in the ward may be informed to transfer the patient to the operation room, by referring to the time when the medical resources required for the operation room is ready. Also, a nurse in the ward may be informed to come to the operation room to pick up the patient, by referring to both the time when the use of the medical resources required for the operation order of the patient is completed and the estimated completion time.

Described above is an explanation based on the embodiments 1-4 of the present invention. These embodiments are intended to be illustrative only and it will be obvious to those skilled in the art that various modifications to constituting elements and processes could be developed and that such modifications are also within the scope of the present invention.

1. A medical service support system which manages a use state of medical instrument used in medical operations with a predetermined task sequence, comprising:
a recording unit operative to record use state specifying information which specifies a use state of medical instrument;
a reading unit operative to read use state specifying information recorded in the recording unit before the medical instrument is used for a certain task;
a first determination unit operative to determine whether the use of the medical instrument for the task follows the task sequence from use state specifying information read; and
a task execution unit operative to execute the task when the first determination unit determines that the task sequence is properly followed.

2. The medical service support system according to claim 1, further comprising:
a writing unit operative to write use state specifying information, which specifies that a task is executed, in the recording unit when the task is executed by the task execution unit.

3. The medical service support system according to claim 1, further comprising:
a task flow memory unit operative to retain a sequence of a series of tasks which constitutes medical operations, wherein
the first determination unit is operative to extract a task to be performed, based on the task sequence retained in the task flow memory unit, from the use state specifying information recorded in the recording unit and determine whether the task for which the medical instrument is about to be used matches the task extracted.

4. The medical service support system according to claim 1, further comprising:
a task flow memory unit operative to retain a sequence of a series of tasks which constitutes medical operations, wherein
the first determination unit is operative to extract current use state specifying information, based on the task sequence retained in the task flow memory unit, from the task for which the medical instrument is about to be used and determine whether the current use state specifying information matches the use state specifying information recorded in the recording unit.

5. The medical service support system according to claim 1, wherein
the recording unit is installed in a medical instrument, and
the first determination unit and the task execution unit are installed in the same task execution device.

6. The medical service support system according to claim 5, wherein
the first determination unit determines whether the use state specifying information read from the recording unit is the information which indicates the completion of the task required to be executed before the task execution by the task execution unit is started.

7. The medical service support system according to claim 1, further comprising:
an order information memory unit operative to store order information indicating an order for a medical practice to be performed;
an order information acquisition unit operative to acquire order information of the medical practice to be started, from the order information memory unit;
a status information acquisition unit operative to acquire status information of a medical resource;
a second determination unit operative to determine from the order information acquired by the order information acquisition unit whether there is a medical practice which requires the use of the medical resource when the status information of the medical resource acquired by the status information acquisition unit indicates the medical resource to be in a usable state; and
an annunciation unit operative to indicate that the order of a medical practice can be executed when the second determination unit determines that there is a medical practice which requires the use of the medical resource.

8. The medical service support system according to claim 7, further comprising:
an assignment processing unit operative to assign the medical resource in a usable state to the order of the medical practice which is indicated by the annunciation unit to be executable.

9. The medical service support system according to claim 8, further comprising:
a status alteration unit operative to alter the status of the medical resource to a state which indicates the medical resource to be used for the medical practice when the medical resource is assigned to the order of the medical practice by the assignment processing unit.

10. The medical service support system according to claim 8, wherein
the annunciation unit announces that preparations for a medical practice can be started when the medical resource is assigned to the order of the medical practice by the assignment processing unit.

11. The medical service support system according to claim 7, wherein
the second determination unit estimates the time required for the status information to indicate the medical resource to be usable when the status information of the medical resource is in a process of being changed to indicate the usable state.

12. The medical service support system according to claim 7, wherein
the annunciation unit announces warning information if predetermined time passes without any assignment processes being performed by the assignment processing unit after the announcement for the order of the medical practice to be performable.

13. The medical service support system according to claim 7, wherein
the order of the medical practice is an endoscopic examination order,
the status information acquisition unit acquires status information of an endoscope, and
the second determination unit determines from order information of endoscopic examination whether there are any endoscopic examinations which require the use of the endoscope when the status information of the endoscope indicates the endoscope to be in a usable state.

14. The medical service support system according to claim 1, further comprising:
a third determination unit operative to produce status information by determining the state of a medical instrument, wherein
the third determination unit produces status information according to the progress of a task when the task is executed by the task execution unit.

15. A medical service support system comprising:
an order information memory unit operative to store order information of a medical practice to be performed;
an order information acquisition unit operative to acquire order information indicating an order for the medical practice which is scheduled to be started, from the order information memory unit;
an status information acquisition unit operative to acquire status information of a medical resource;
a determination unit operative to determine from the order information acquired by the order information acquisition unit whether there is the medical practice which requires the use of the medical resource when the status information of the medical resource acquired by the status information acquisition unit indicates the medical resource to be in a usable state; and
an annunciation unit operative to announce that the order of a medical practice can be executed when the determination unit determines that there is a medical practice which requires the use of the medical resource.
